(19) United States
(12) Patent Application Publication
(10) Pub. No.: US 2017/0135127 A1
(43) Pub. Date: May 11, 2017

(54) USER EQUIPMENTS, BASE STATIONS AND METHODS

(71) Applicant: Sharp Laboratories of America, Inc., Camas, WA (US)

(72) Inventors: Toshizo Nogami, Vancouver, WA (US); Zhanping Yin, Vancouver, WA (US)

(21) Appl. No.: 15/342,995

(22) Filed: Nov. 3, 2016

Related U.S. Application Data
(60) Provisional application No. 62/251,475, filed on Nov. 5, 2015.

(51) Int. Cl. H04W 72/12; H04W 72/04

(52) U.S. Cl. CPC H04W 72/1289; H04W 72/0453; H04W 72/1205

(57) ABSTRACT

A user equipment (UE) is described. The UE includes a higher layer processor configured to acquire a Radio Resource Control (RRC) message (also referred to as higher layer signaling) for configuration of a first serving cell and an RRC message for configuration of a second serving cell as a scheduling cell for the first serving cell. The UE also includes a physical downlink control channel receiver configured to monitor a physical downlink control channel (PDCCH) with a first DCI format on the first serving cell, the PDCCH with the first DCI format scheduling a physical downlink shared channel (PDSCH) in the first serving cell. The physical downlink control channel receiver is also configured to monitor a PDCCH with a second DCI format on the second serving cell, the PDCCH with the second DCI format scheduling a PDSCH in the first serving cell.

### RELATED APPLICATIONS

This application is related to and claims priority from U.S. Provisional Patent Application No. 62/251,475, entitled “USER EQUIPMENTS, BASE STATIONS AND METHODS,” filed on Nov. 5, 2015, which is hereby incorporated by reference herein, in its entirety.

### TECHNICAL FIELD

The present disclosure relates generally to communication systems. More specifically, the present disclosure relates to user equipments (UEs), base stations and methods.

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and/or efficiency have been sought. However, improving communication capacity, speed, flexibility and/or efficiency may present certain problems.

For example, wireless communication devices may communicate with one or more devices using a communication structure. However, the communication structure used may only offer limited flexibility and/or efficiency. As illustrated by this discussion, systems and methods that improve communication flexibility and/or efficiency may be beneficial.

### BRIEF DESCRIPTION OF THE DRAWINGS

FIG. 1 is a block diagram illustrating one implementation of one or more evolved NodeBs (eNBs) and one or more user equipments (UEs) in which systems and methods for licensed assisted access (LAA) may be implemented;

FIG. 2 is block diagram illustrating a detailed configuration of an eNB and a UE in which systems and methods for LAA may be implemented;

FIG. 3 is a flow diagram illustrating a method for LAA by a UE;

FIG. 4 is a flow diagram illustrating a method for LAA by an eNB;

FIG. 5 is a block diagram illustrating an example of self-scheduling within a licensed carrier;

FIG. 6 is a block diagram illustrating an example of cross-carrier scheduling among licensed carriers;

FIG. 7 illustrates an example of a first enhanced resource-element group (EREG)/enhanced control channel element (ECCE) structure;

FIG. 8 is a block diagram illustrating an example of self-scheduling within an unlicensed carrier;

FIG. 9 illustrates an example of a second EREG/ECCE structure;

FIGS. 10A and 10B show examples of ECCE aggregation according to the second ECCE structure;

FIG. 11 is a block diagram illustrating an example of cross-carrier scheduling for LAA carriers;

FIG. 12 is a block diagram illustrating an example of search space sharing among scheduled serving cells;

FIG. 13 is a block diagram illustrating another example of search space sharing among scheduled serving cells;

FIG. 14 is a block diagram illustrating an example of search space sharing for downlink (DL) assignment and uplink (UL) grant;

FIG. 15 is a block diagram illustrating another example of search space sharing for DL assignment and UL grant;

FIG. 16 is a block diagram illustrating yet another example of search space sharing for DL assignment and UL grant;

FIG. 17 is a block diagram illustrating an example of PDCCH-based self-scheduling for an LAA cell;

FIG. 18 is a block diagram illustrating another example of PDCCH-based cross-carrier scheduling for an LAA cell;

FIG. 19 is a diagram illustrating one example of a radio frame that may be used in accordance with the systems and methods disclosed herein;

FIG. 20 is a diagram illustrating one example of a resource grid;

FIG. 21 illustrates various components that may be utilized in a UE;

FIG. 22 illustrates various components that may be utilized in an eNB;

FIG. 23 is a block diagram illustrating one implementation of a UE in which systems and methods for performing LAA may be implemented; and

FIG. 24 is a block diagram illustrating one implementation of an eNB in which systems and methods for performing LAA may be implemented.

### DETAILED DESCRIPTION

A user equipment (UE) is described. The UE includes a higher layer processor configured to acquire a Radio Resource Control (RRC) message (also referred to as higher layer signaling) for configuration of a first serving cell and an RRC message for configuration of a second serving cell as a scheduling cell for the first serving cell. The UE also includes a physical downlink control channel receiver configured to monitor a physical downlink control channel (PDCCH) with a first DCI format on the first serving cell, the PDCCH with the first DCI format scheduling a physical downlink shared channel (PDSCH) in the first serving cell. The physical downlink control channel receiver is also configured to monitor a PDCCH with a second DCI format on the second serving cell, the PDCCH with the second DCI format scheduling a PDSCH in the first serving cell.

The higher layer processor may be further configured to acquire an RRC message for configuration of a third serving cell as another scheduling cell for the first serving cell. The physical downlink control channel receiver may be further configured, upon the configuration of the third serving cell, to monitor the PDCCH with the first DCI format on the third serving cell instead of the first serving cell.

A method is also described. The method includes acquiring an RRC message for configuration of a first serving cell and an RRC message for configuration of a second serving cell as a scheduling cell for the first serving cell. The method also includes monitoring a PDCCH with a first DCI format on the first serving cell, the PDCCH with the first DCI format scheduling a physical downlink shared channel (PDSCH) in the first serving cell. The method further includes monitoring a PDCCH with a second DCI format on the second serving cell, the PDCCH with the second DCI format scheduling a PDSCH in the first serving cell.

An evolved NodeB (eNB) is also described. The eNB includes a higher layer processor configured to transmit an RRC message for configuration of a first serving cell and an RRC message for configuration of a second serving cell as a scheduling cell for the first serving cell. The eNB also includes a physical downlink control channel transmitter configured to transmit a PDCCH, which schedules a PDSCH in the first serving cell, on the first serving cell when a first DCI format is used. The physical downlink control channel transmitter is also configured to transmit a PDCCH, which schedules the PDSCH in the first serving cell, on the second serving cell when a second DCI format is used.

The higher layer processor may be further configured to transmit an RRC message for configuration of a third serving cell as another scheduling cell for the first serving cell. The physical downlink control channel transmitter may be further configured, upon the configuration of the third serving cell, to transmit the PDCCH with the first DCI format on the third serving cell instead of the first serving cell.

Another method is described. The method includes transmitting an RRC message for configuration of a first serving cell and an RRC message for configuration of a second serving cell as a scheduling cell for the first serving cell. The method also includes transmitting a PDCCH, which schedules a PDSCH in the first serving cell, on the first serving cell when a first DCI format is used. The method further includes transmitting a PDCCH, which schedules the PDSCH in the first serving cell, on the second serving cell when a second DCI format is used.

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A) and other standards (e.g., 3GPP Releases 8, 9, 10, 11 and/or 12). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.” A UE may also be more generally referred to as a terminal device.

In 3GPP specifications, a base station is typically referred to as a Node B, an evolved Node B (eNB), a home enhanced or evolved Node B (HeNB) or some other similar terminology. As the scope of the disclosure should not be limited to 3GPP standards, the terms “base station,” “Node B,” “eNB,” and “HeNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An eNB may also be more generally referred to as a base station device.

It should be noted that as used herein, a “cell” may refer to any set of communication channels over which the protocols for communication between a UE and eNB that may be specified by standardization or governed by regulatory bodies to be used for International Mobile Telecommunications-Advanced (IMT-Advanced) or its extensions and all of it or a subset of it may be adopted by 3GPP as licensed bands (e.g., frequency bands) to be used for communication between an eNB and a UE. “Configured cells” are those cells of which the UE is aware and is allowed by an eNB to transmit or receive information. “Configured cell(s)” may be serving cell(s). The UE may receive system information and perform the required measurements on all configured cells. “Activated cells” are those configured cells on which the UE is transmitting and receiving. That is, activated cells are those cells for which the UE monitors the physical downlink control channel (PDCCH) and in the case of a downlink transmission, those cells for which the UE decodes a physical downlink shared channel (PDSCH). “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics.

The systems and methods disclosed may involve carrier aggregation. Carrier aggregation refers to the concurrent utilization of more than one carrier. In carrier aggregation, more than one cell may be aggregated to a UE. In one example, carrier aggregation may be used to increase the effective bandwidth available to a UE. The same TDD uplink-downlink (UL/DL) configuration has to be used for TDD CA in Release-10, and for intra-band CA in Release-11. In Release-11, inter-band TDD CA with different TDD UL/DL configurations is supported. The inter-band TDD CA with different TDD UL/DL configurations may provide the flexibility of a TDD network in CA deployment. Furthermore, enhanced interference management with traffic adaptation (eIMTA) (also referred to as dynamic UL/DL reconfiguration) may allow flexible TDD UL/DL reconfiguration based on the network traffic load.

It should be noted that the term “concurrent” and variations thereof as used herein may denote that two or more events may overlap each other in time and/or may occur near in time to each other. Additionally, “concurrent” and variations thereof may or may not mean that two or more events occur at precisely the same time.

Licensed-assisted access (LAA) may support LTE in unlicensed spectrum. In a LAA network, the DL transmission may be scheduled in an opportunistic manner. For fairness utilization, an LAA eNB may perform functions such as clear channel assessment (CCA), listen before talk (LBT) and dynamic frequency selection (DFS) before transmission. When the eNB performs LBT, the eNB cannot transmit any signals including reference signals.

Due to LBT, the eNB may not know whether it is allowed to transmit a physical downlink shared channel (PDSCH). On the other hand, for the same subframe, the eNB may know that it is allowed to transmit some signal in another carrier, which may carry control channel associated with the PDSCH.

The described systems and methods provide for transmitting the control channel in an LAA network. In general, preparation of control channel (PDCCH/EPDCCH) starts somewhat earlier (e.g. 1 millisecond (ms)) than the actual transmission timing, even if successful channel access on a scheduled LAA SCell has not been done at that time. In this instance, self-scheduling may be beneficial. If channel access fails, all signals on the LAA SCell, including the prepared PDCCH/EPDCCH, are not transmitted. In contrast, for cross-carrier scheduling, the prepared PDCCH/EPDCCH may have to be transmitted without the corresponding PDSCH transmission on the LAA SCell due to the channel access failure. This may cause unnecessary NACK reporting. On the other hand, cross-carrier scheduling may have some advantage in terms of interference coordination on the control channels. Therefore, it may be beneficial to support both self and cross-carrier scheduling methods simultaneously for scheduling for a single serving cell. Moreover, it may also be useful to support cross-carrier scheduling from multiple scheduling cells. One approach is to separate search spaces with respect to DCI formats.

In a single subframe, a UE may monitor a PDCCH with the first DCI format and a PDCCH with the second DCI format on the first and second serving cells, respectively. The first DCI format may be DCI format 0/1A. The second DCI format may be the other DCI format that can carry DL resource block assignment.

Various examples of the systems and methods disclosed herein are now described with reference to the Figures, where like reference numbers may indicate functionally similar elements. The systems and methods as generally described and illustrated in the Figures herein could be arranged and designed in a wide variety of different implementations. Thus, the following more detailed description of several implementations, as represented in the Figures, is not intended to limit scope, as claimed, but is merely representative of the systems and methods.

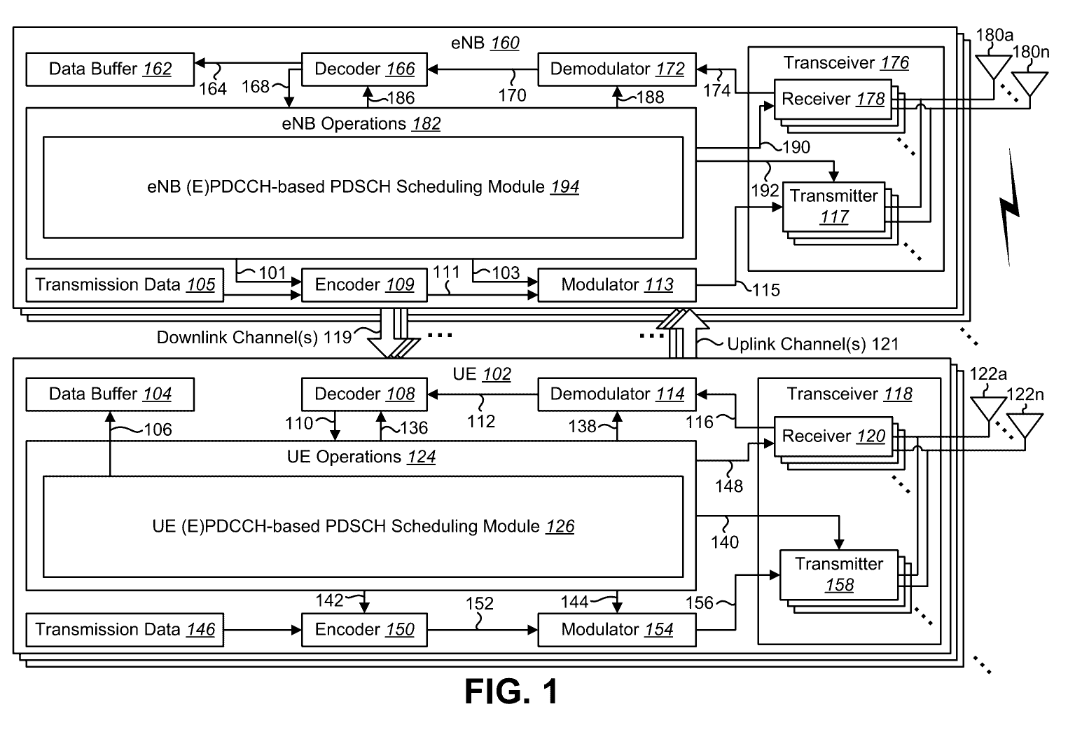

FIG. 1 is a block diagram illustrating one implementation of one or more eNBs 160 and one or more UEs 102 in which systems and methods for LAA may be implemented. The one or more UEs 102 communicate with one or more eNBs 160 using one or more antennas 122a-n. For example, a UE 102 transmits electromagnetic signals to the eNB 160 and receives electromagnetic signals from the eNB 160 using the one or more antennas 122a-n. The eNB 160 communicates with the UE 102 using one or more antennas 180a-n.

The UE 102 and the eNB 160 may use one or more channels 119, 121 to communicate with each other. For example, a UE 102 may transmit information or data to the eNB 160 using one or more uplink channels 121. Examples of uplink channels 121 include a PUCCH and a PUSCH, etc. The one or more eNBs 160 may also transmit information or data to the one or more UEs 102 using one or more downlink channels 119, for instance. Examples of downlink channels 119 include a PDCCH, a PDSCH, etc. Other kinds of channels may be used.

Each of the one or more UEs 102 may include one or more transceivers 118, one or more demodulators 114, one or more decoders 108, one or more encoders 150, one or more modulators 154, a data buffer 104 and a UE operations module 124. For example, one or more reception and/or transmission paths may be implemented in the UE 102. For convenience, only a single transceiver 118, decoder 108, demodulator 114, encoder 150 and modulator 154 are illustrated in the UE 102, though multiple parallel elements (e.g., transceivers 118, decoders 108, demodulators 114, encoders 150 and modulators 154) may be implemented.

The transceiver 118 may include one or more receivers 120 and one or more transmitters 158. The one or more receivers 120 may receive signals from the eNB 160 using one or more antennas 122a-n. For example, the receiver 120 may receive and downconvert signals to produce one or more received signals 116. The one or more received signals 116 may be provided to a demodulator 114. The one or more transmitters 158 may transmit signals to the eNB 160 using one or more antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce decoded signals 110, which may include a UE-decoded signal 106 (also referred to as a first UE-decoded signal 106). For example, the first UE-decoded signal 106 may comprise received payload data, which may be stored in a data buffer 104. Another signal included in the decoded signals 110 (also referred to as a second UE-decoded signal 110) may comprise overhead data and/or control data. For example, the second UE-decoded signal 110 may provide data that may be used by the UE operations module 124 to perform one or more operations.

As used herein, the term “module” may mean that a particular element or component may be implemented in hardware, software or a combination of hardware and software. However, it should be noted that any element denoted as a “module” herein may alternatively be implemented in hardware. For example, the UE operations module 124 may be implemented in hardware, software or a combination of both.

In general, the UE operations module 124 may enable the UE 102 to communicate with the one or more eNBs 160. The UE operations module 124 may include one or more of a UE (E)PDCCH-based PDSCH scheduling module 126.

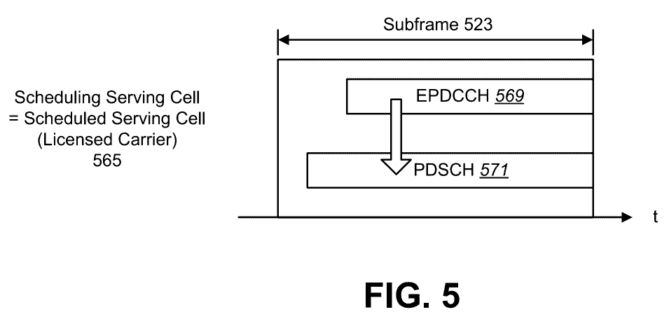

A UE 102 may be configured with self-scheduling or cross-carrier scheduling. If the UE 12 is not configured with cross-carrier scheduling or if the UE 102 is not configured with a carrier indicator field (CIF), then the physical downlink control channel (PDCCH) or enhanced physical downlink control channel (EPDCCH) of a serving cell may schedule resources on that serving cell. An example of self-scheduling is described in connection with FIG. 5.

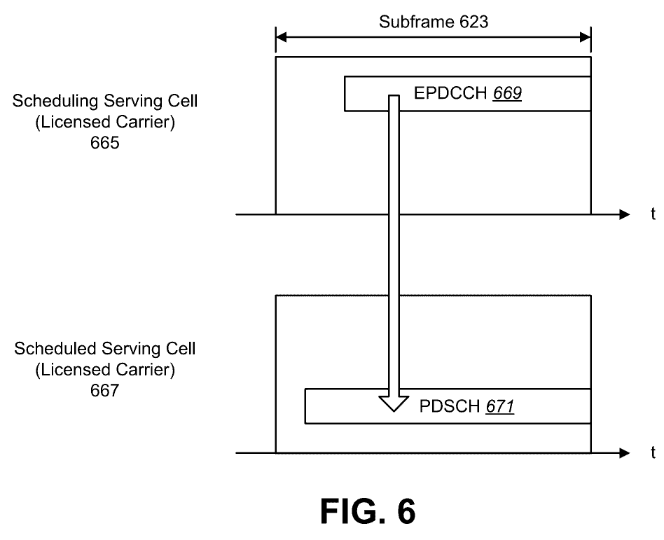

Cross-carrier scheduling with the CIF may allow the (E)PDCCH of a serving cell to schedule resources on another serving cell. An example of cross-carrier scheduling is described in connection with FIG. 6.

For cross-carrier scheduling among licensed carriers, the following restrictions may be adopted. Cross-carrier scheduling may not apply to the primary cell (PCell). The PCell may be scheduled via its (E)PDCCH. When the (E)PDCCH of a secondary cell (SCell) is configured, cross-carrier scheduling may not apply to this SCell. In this case, the SCell may be scheduled via its (E)PDCCH. When the (E)PDCCH of an SCell is not configured, cross-carrier scheduling applies and this SCell is always scheduled via the (E)PDCCH of one other serving cell.

A linking between uplink (UL) and downlink (DL) may allow identifying the serving cell for which the DL assignment or UL grant applies when the CIF is not present. A DL assignment received on a PCell may correspond to downlink transmission on the PCell. An UL grant received on a PCell may correspond to uplink transmission on the PCell. A DL assignment received on SCell n may correspond to downlink transmission on SCell n. An UL grant received on SCell n may correspond to uplink transmission on SCell n. If SCell n is not configured for uplink usage by the UE 102, then the grant may be ignored by the UE 102.

When Dual Connectivity (DC) is configured, cross-carrier scheduling can be used across serving cells within the same cell group (CG). Within a CG, neither the PCell of the MCG nor the primary secondary cell (PSCell) of the SCG can be cross-carrier scheduled.

A UE 102 configured with the CIF for a given serving cell may assume that the CIF is not present in any PDCCH of the serving cell in the common search space, which is defined in PCell or pSCell. Otherwise, the configured UE 102 may assume that for the given serving cell, the CIF is present in the PDCCH/EPDCCH located in the UE-specific search space when the PDCCH/EPDCCH cyclic redundancy check (CRC) is scrambled by C-RNTI or SPS C-RNTI.

The CIF presence on a given serving cell and the cross-carrier scheduling for the serving cell may be independently configured. The information element (IE) CrossCarrierSchedulingConfig may be used to specify the configuration when the cross-carrier scheduling is used in a cell. Listing (1) illustrates an example of the CrossCarrierSchedulingConfig information element.

Listing (1)

-- ASN1START

| | |
|---|---|
| CrossCarrierSchedulingConfig-r10 ::= | SEQUENCE { |
| schedulingCellInfo-r10 | CHOICE { |
| own-r10 | SEQUENCE { -- No cross |
| | carrier scheduling |
| cif-Presence-r10 | BOOLEAN |
| }, | |
| other-r10 | SEQUENCE { -- Cross carrier |
| | scheduling |
| schedulingCellId-r10 | ServCellIndex-r10, |
| pdsch-Start-r10 | INTEGER (1..4) |
| } | |
| } | |
| } | |
| -- ASN1STOP | |

In Listing (1), the field cif-Presence is a field used to indicate whether carrier indicator field is present (value TRUE) or not (value FALSE) in PDCCH/EPDCCH downlink control information (DCI) formats.

The field pdsch-Start is the starting OFDM symbol of PDSCH for the concerned SCell. Values 1, 2, 3 are applicable when dl-Bandwidth for the concerned SCell is greater than 10 resource blocks. Values 2, 3, 4 are applicable when dl-Bandwidth for the concerned SCell is less than or equal to 10 resource blocks.

The field schedulingCellId indicates which cell signals the downlink allocations and uplink grants, if applicable, for the concerned SCell. In the case where the UE 102 is configured with DC, the scheduling cell is part of the same cell group (i.e., master cell group (MCG) or secondary cell group (SCG)) as the scheduled cell.

The set of PDCCH candidates to monitor may be defined in terms of search spaces. The UE 102 may monitor a set of EPDCCH candidates on one or more activated serving cells as configured by higher layer signaling for control information. In this case, monitoring implies attempting to decode each of the EPDCCHs in the set according to the monitored DCI formats. The set of EPDCCH candidates to monitor may be defined in terms of EPDCCH UE-specific search spaces.

A UE 102 may be configured to monitor EPDCCH candidates in a given serving cell with a given DCI format size with CIF, and CRC scrambled by C-RNTI. When the EPDCCH candidates have one or more possible values of CIF for the given DCI format size, the UE 102 may assume that an EPDCCH candidate with the given DCI format size is transmitted in the given serving cell in any EPDCCH UE-specific search space corresponding to any of the possible values of CIF for the given DCI format size.

A UE EPDCCH starting position module 126 may determine the starting position for monitoring EPDCCH. For EPDCCH scheduling a normal cell's PDSCH, the EPDCCH starting position on the serving cell may be described as the following regardless of whether the EPDCCH schedules the serving cell's resources or another serving cell's resources. EPDCCH may be mapped to a set of downlink resource elements. Each downlink resource element may be indexed as (k,l) in a physical resource-block (PRB) pair configured for possible EPDCCH transmission of an EPDCCH set, where k is the frequency domain index and l is the time domain index.

A PRB is defined as 7 and 6 consecutive OFDM symbols for normal CP and extended CP in the time domain, respectively. A PRB is defined as 12 consecutive subcarriers in the frequency domain. The PRBs are numbered in the order of increasing frequency in the frequency domain. A PRB pair is defined as the two PRBs in one subframe having the same PRB index (PRB number).

The index l in the first slot in a subframe fulfils l≧l_{EPDCCHStart}. More specifically, the possible EPDCCH starting symbols are OFDM symbol #1, #2, #3 and #4 in the first slot of a subframe.

For a given serving cell, the UE 102 may be configured via higher layer signaling to receive PDSCH data transmissions according to transmission modes 1-9. If the UE 102 is configured with a higher layer parameter epdcch-StartSymbol-r11, then the starting OFDM symbol for EPDCCH given by index l_{EPDCCHStart} in the first slot in a subframe may be determined from the higher layer parameter. Otherwise, the starting OFDM symbol for EPDCCH given by index l_{EPDCCHStart} in the first slot in a subframe may be given by the CFI value in the subframe of the given serving cell when N_{RB}^{DL}>10, and l_{EPDCCHStart} may be given by the CFI value+1 in the subframe of the given serving cell when N_{RB}^{DL}≦10.

For a given serving cell, if the UE 102 is configured via higher layer signaling to receive PDSCH data transmissions according to transmission mode 10, then for each EPDCCH-physical resource block (PRB)-set, the starting OFDM symbol for monitoring EPDCCH in subframe k is determined from the higher layer parameter pdsch-Start-r11. If the value of the parameter pdsch-Start-r11 belongs to {1,2,3,4}, then l′_{EPDCCHStart} may be given by the higher layer parameter pdsch-Start-r11. Otherwise, l′_{EPDCCHStart} may be given by the CFI value in subframe k of the given serving cell when N_{RB}^{DL}>10, and l′_{EPDCCHStart} may be given by the CFI value+1 in subframe k of the given serving cell when N_{RB}^{DL}≦10.

Furthermore, if subframe k is indicated by the higher layer parameter mbsfn-SubframeConfigList-r11, or if subframe k is subframe 1 or 6 for frame structure type 2, then l_{EPDCCHStart}=min(2,l′_{EPDCCHStart}). Otherwise, l_{EPDCCHStart}=l′_{EPDCCHStart}.

Demodulation reference signals (DM-RSs) associated with EPDCCH may be transmitted on antenna port 107-110. The DM-RSs are present and are valid references for EPDCCH demodulation only if the EPDCCH transmission is associated with the corresponding antenna ports. The DM-RSs may be transmitted PRBs upon which the corresponding EPDCCH is mapped.

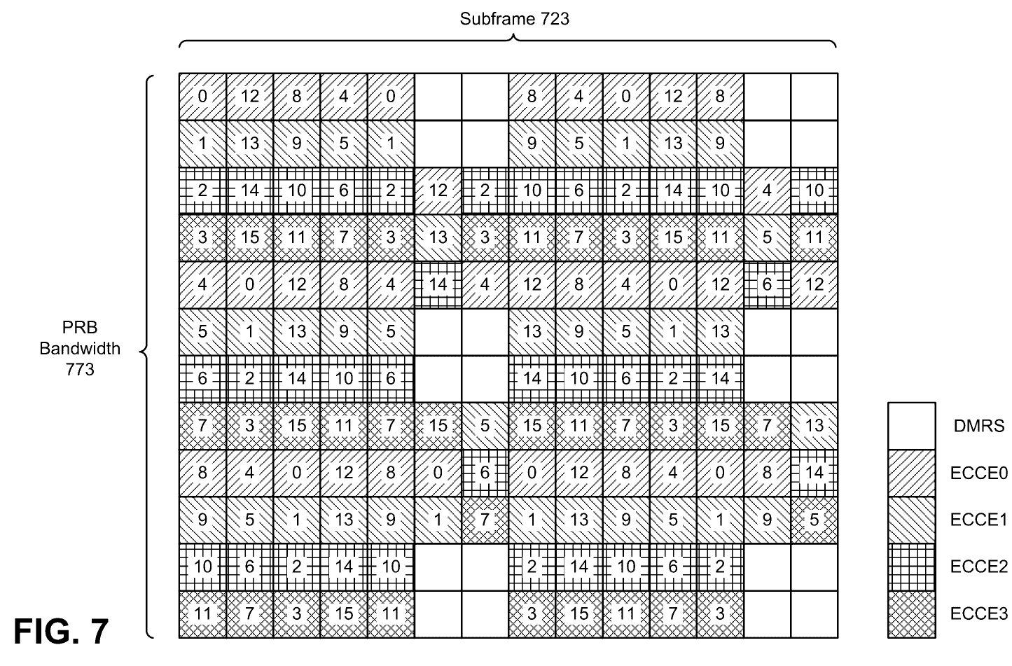

A UE EREG/ECCE structure module 128 may determine an EREG/ECCE structure for monitoring an EPDCCH. An EREG may be used for defining the mapping of enhanced control channels to resource elements. FIG. 7 shows an example of an EREG and an ECCE structure.

The EPDCCH formats may also be defined. The EPDCCH carries scheduling assignments. An EPDCCH may be transmitted using an aggregation of one or several consecutive ECCEs. Each ECCE may consist of multiple EREGs. The number of EREGs per ECCE, N_{EREG}^{ECCE} is given by Table (1). The number of ECCEs used for one EPDCCH may depend on the EPDCCH format as given by Table (2). Both localized and distributed transmission may be supported. An EPDCCH can use either localized or distributed transmission, differing in the mapping of ECCEs to EREGs and PRB pairs.

TABLE 1

| Normal cyclic prefix | | | Extended cyclic prefix | |
|---|---|---|---|---|
| | Special | Special | | Special |
| | subframe, | subframe, | | subframe, |
| Normal | configuration | configuration | Normal | configuration |
| subframe | 3, 4, 8 | 1, 2, 6, 7, 9 | subframe | 1, 2, 3, 5, 6 |

| | |
|---|---|
| 4 | 8 |

TABLE 2

| | Number of ECCEs for one EPDCCH | | | |
|---|---|---|---|---|
| | Case A | | Case B | |
| EPDCCH | Localized | Distributed | Localized | Distributed |
| format | transmission | transmission | transmission | transmission |
| 0 | 2 | 2 | 1 | 1 |
| 1 | 4 | 4 | 2 | 2 |
| 2 | 8 | 8 | 4 | 4 |
| 3 | 16 | 16 | 8 | 8 |
| 4 | — | 32 | — | 16 |

A UE 102 may monitor multiple EPDCCHs. One or two sets of physical resource-block pairs that a UE 102 monitors for EPDCCH transmissions may be configured. All EPDCCH candidates in EPDCCH set Xₘ may use either only localized or only distributed transmission as configured by higher layers. Within EPDCCH set Xₘ in subframe i, the ECCEs available for transmission of EPDCCHs are numbered from 0 to N_{ECCE,m,i}−1.

ECCE number n corresponds to EREGs numbered (n mod N_{ECCE}^{RB})+jN_{ECCE}^{RB} in PRB index └n/N_{ECCE}^{RB}┘ for localized mapping. Alternatively, ECCE number n corresponds to EREGs numbered └n/N_{RB}^{X}^{ₘ}┘+jN_{ECCE}^{RB} in PRB indices (n+j max(1,N_{RB}^{X}^{ₘ}/N_{EREG}^{ECCE}))mod N_{RB}^{X}^{ₘ} for distributed mapping. In this case, j=0, 1, . . . , N_{EREG}^{ECCE}−1, N_{EREG}^{ECCE} is the number of EREGs per ECCE, and N_{ECCE}^{RB}=16/N_{EREG}^{ECCE} is the number of ECCEs per resource-block pair. The physical resource-block pairs constituting EPDCCH set Xₘ are in this paragraph assumed to be numbered in ascending order from 0 to N_{RB}^{X}^{ₘ}−1.

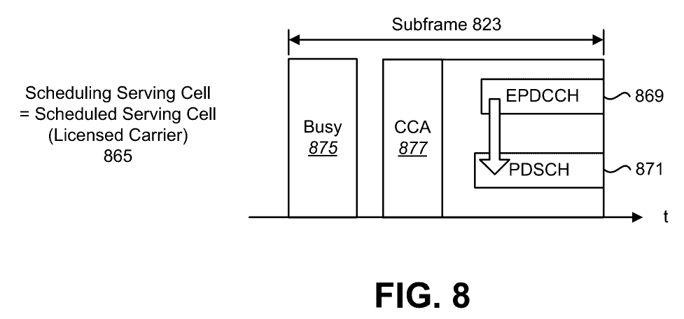

Self-scheduling for a licensed assisted access (LAA) SCell may also be defined. In an LAA SCell, even when the beginning of a given subframe is occupied by the other node, physical channel/signal transmission in the same subframe may start if it is ensured by LBT that the channel is clear in the middle of the subframe. Until ensuring that channel is clear, the eNB 160 may not transmit any DL signal (including PDSCH and EPDCCH). Here, the UE 102 does not know when the eNB 160 starts to transmit the DL signal. More specifically, the possible EPDCCH starting symbols may be an OFDM symbol other than OFDM symbol #1, #2, #3 and #4 in the first slot of a subframe. Also, the possible EPDCCH starting symbols may be an OFDM symbol in the second slot of the subframe. An example of self-scheduling for an LAA SCell is described in connection with FIG. 8.

There may be several options for the UE 102 to know the starting position of EPDCCH. In a first option (Option 1), the EPDCCH may have a fixed starting position. In the first option, the eNB 160 can transmit the EPDCCH only when it ensures availability of the channel before the fixed EPDCCH starting position (e.g., m-th OFDM symbol of a subframe, or n-th OFDM symbol in the second slot of a subframe). The UE 102 may attempt the EPDCCH blind decoding assuming the EPDCCH starts at the position.

For the first option, instead of the EPDCCH starting position derivation described above, the UE 102 may assume l_{EPDCCHStart}=l^{LAA}_{EPDCCHStart}, where l^{LAA}_{EPDCCHStart} is a fixed value. The index l in the first slot in a subframe fulfils l≧8 (i.e. no RE is available in the first slot). The index l in the second slot in a subframe fulfils l≧l_{EPDCCHStart}.

In a second option (Option 2), the UE 102 may perform blind decoding of EPDCCH with multiple possible starting positions. In the second option, the eNB 160 can determine the EPDCCH starting position according to when it ensures availability of the channel. In an implementation, the EPDCCH may be allowed to start only at limited possible starting positions so that the number of blind decoding attempts is reduced. The UE 102 may attempt the EPDCCH blind decoding assuming each possible EPDCCH starting position. During EPDCCH blind decoding, the UE 102 may check CRC bits that are attached to the DCI format carried via the EPDCCH. This means that the UE 102 may know the exact EPDCCH starting position by a successful decoding of the EPDCCH.

For the second option, instead of the EPDCCH starting position derivation described above, the UE 102 may assume l_{EPDCCHStart}=l^{LAA}_{EPDCCHStart}, where candidates of l^{LAA}_{EPDCCHStart} are predefined. Also each candidate may be linked to a corresponding s value. The possible values of s are 0 and 1. If s=0, the index l in the first slot in a subframe fulfils l≧l_{EPDCCHStart}, otherwise the index l in the first slot in a subframe fulfils l≧8 (i.e. no RE is available in the first slot) and the index l in the second slot in a subframe fulfils l≧l_{EPDCCHStart}.

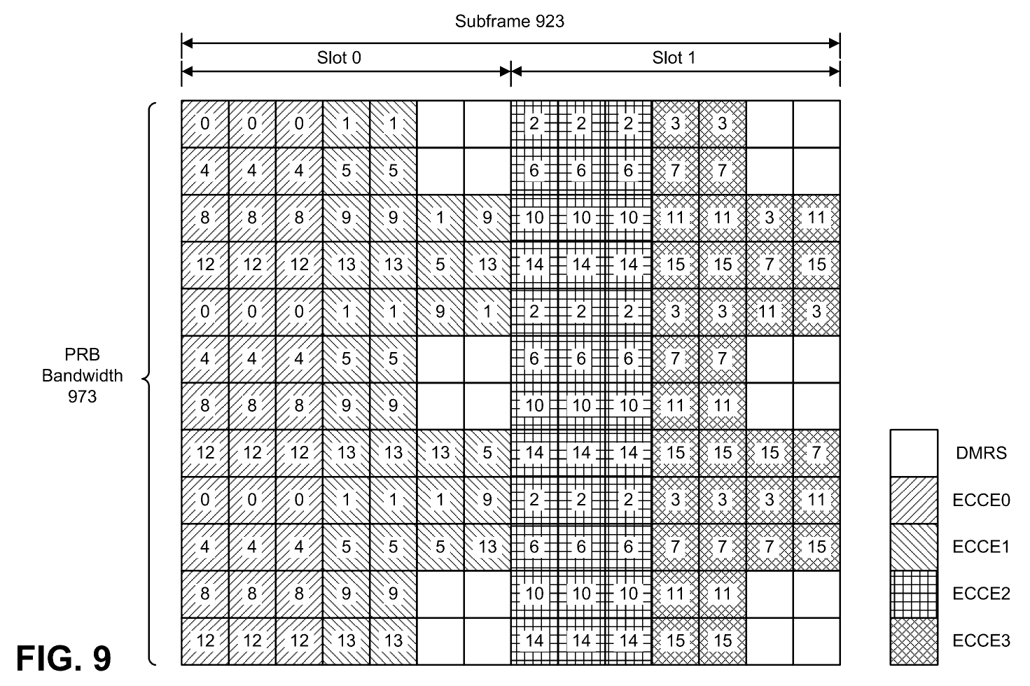

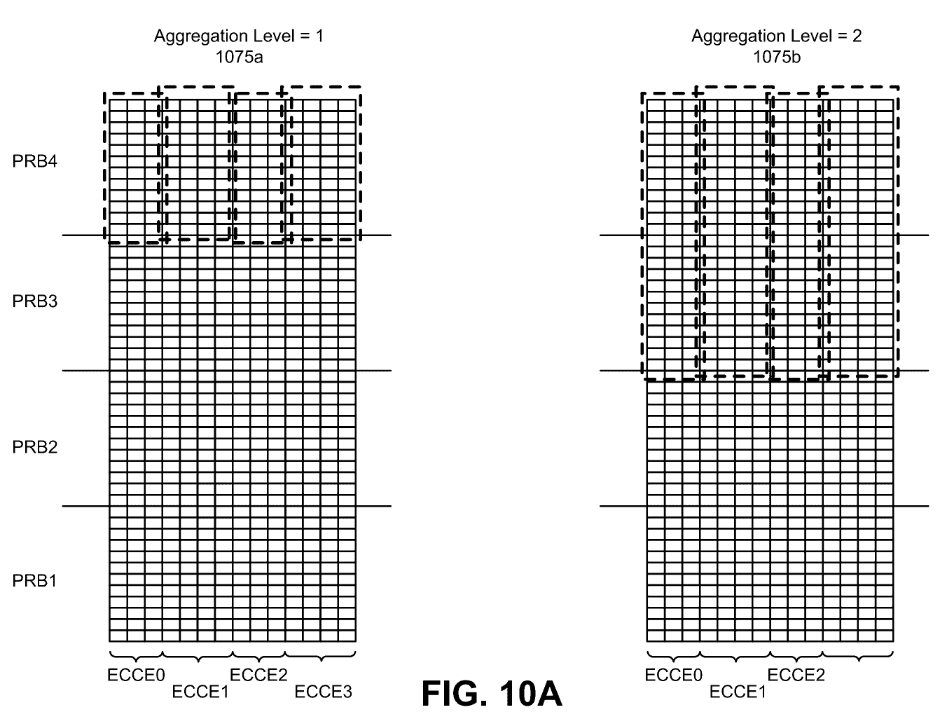

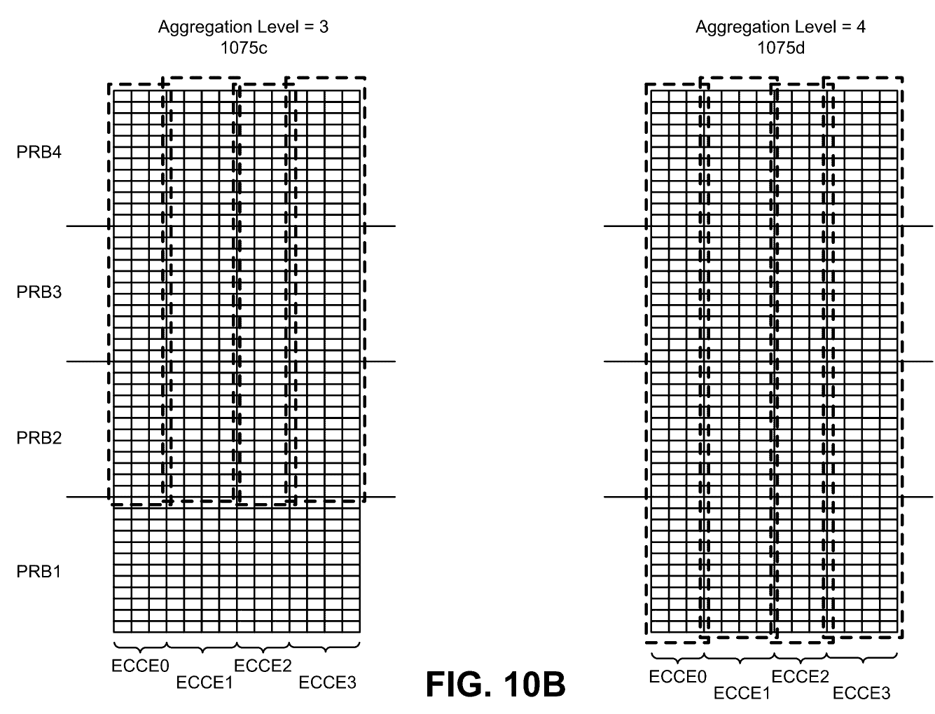

Alternatively, for the second option, a new EREG and/or ECCE design may be beneficial. In this case, of the EPDCCH starting position for the normal cell (i.e. the EPDCCH starting position derived from either epdcch-StartSymbol-r11, pdsch-Start-r11 or CFI value) may be used for the LAA cell. An example of this EREG/ECCE structure is described in connection with FIG. 9. FIGS. 10A and 10B show examples of ECCE aggregation with the new ECCE structure.

In a third option (Option 3), the UE 102 may perform blind detection of a reference/synchronization/initial signal of which position corresponds to EPDCCH starting position. In the third option, the eNB 160 can determine the EPDCCH starting position according to when it ensures availability of the channel. The eNB 160 may transmit some kind of known signal (e.g., a reference signal, a synchronization signal or an initial signal (a preamble sequence)) together with EPDCCH. The UE 102 may try to detect the location of that signal by assessing the correlation of the reception signal and the known signal. After detecting the location of that signal, the UE 102 may attempt the EPDCCH blind decoding assuming a single EPDCCH starting position derived from the location of that signal. For example, a relative position of the EPDCCH from the location of that signal may be fixed. Alternatively, the eNB 160 and the UE 102 may share a table that specifies a correspondence relationship between the EPDCCH starting position and the location of that signal.

For the third option, instead of the EPDCCH starting position derivation described above, the UE 102 may assume l_{EPDCCHStart}=l^{LAA}_{EPDCCHStart}, where l^{LAA}_{EPDCCHStart} is derived from the detected reference/synchronization/initial signal resource. The UE 102 may also obtain an s value depending on the detected reference/synchronization/initial signal resource. The possible values of s are 0 and 1. If s=0, the index l in the first slot in a subframe fulfils l≧l_{EPDCCHStart}, otherwise the index l in the first slot in a subframe fulfils l≧8 (i.e., no RE is available in the first slot) and the index l in the second slot in a subframe fulfils l≧l_{EPDCCHStart}.

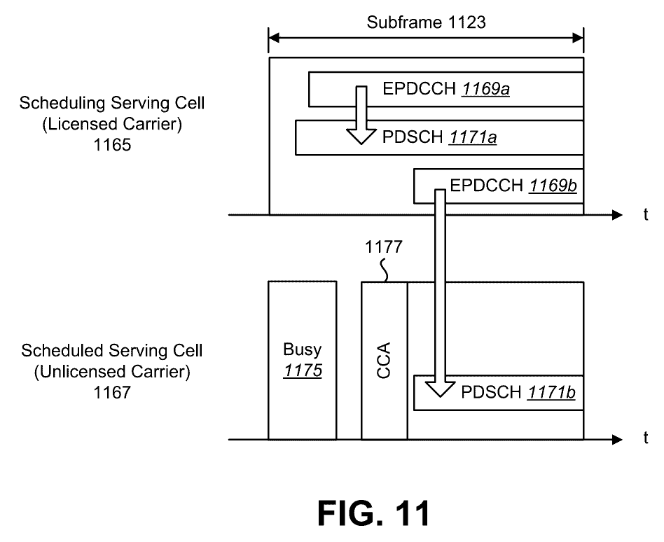

Cross-carrier scheduling for an LAA SCell may also be defined. The EPDCCH starting position in the licensed carrier does not have to be located posterior to the LBT timing on the LAA SCell. However, for cross-carrier scheduling for the LAA SCell, scheduling of the EPDCCH in the non-LAA serving cell may start after ensuring the clear channel on the LAA SCell. Therefore, the above-described EPDCCH mapping on the LAA SCell can be used for an EPDCCH cross-carrier scheduling of resources on the LAA SCell. An example of cross-carrier scheduling for LAA carriers is described in connection with FIG. 11. Meanwhile, a self-scheduling EPDCCH in the non-LAA serving cell may start independently of the LBT on the LAA SCell as shown in FIG. 11.

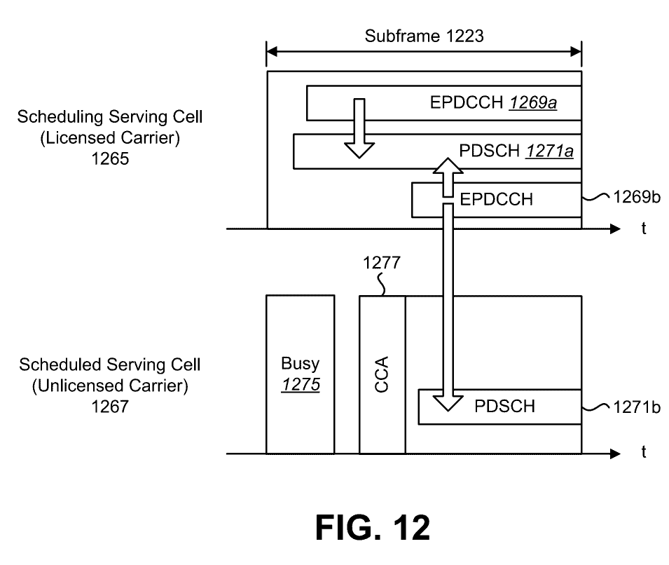

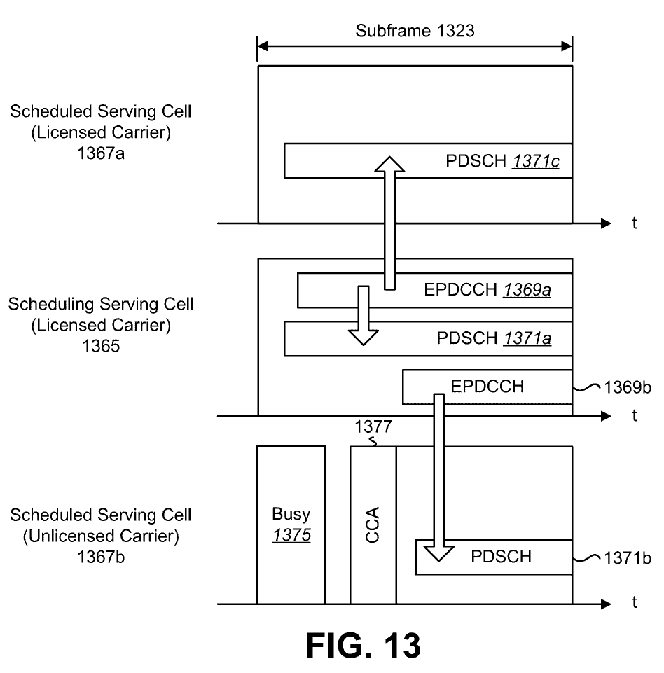

If the UE 102 is configured with a CIF and if the DCI format size is the same, then the search space for the EPDCCH scheduling resources on the LAA SCell may be used for self-scheduling. More specifically, the eNB 160 may transmit the EPDCCH for the non-LAA cell using the search space for the EPDCCH for the LAA cell. Examples of search space sharing among scheduled serving cells are described in connection with FIGS. 12 and 13.

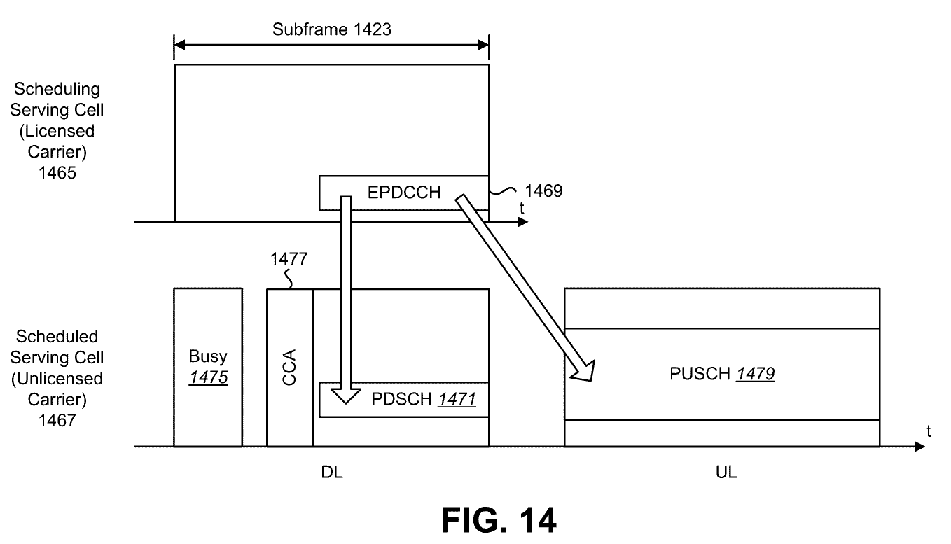

In one approach, EPDCCH search spaces (or an EPDCCH PRB set with the new EREG/ECCE structure) may be shared by DL assignment and UL grant. This may be accomplished as illustrated in FIG. 14.

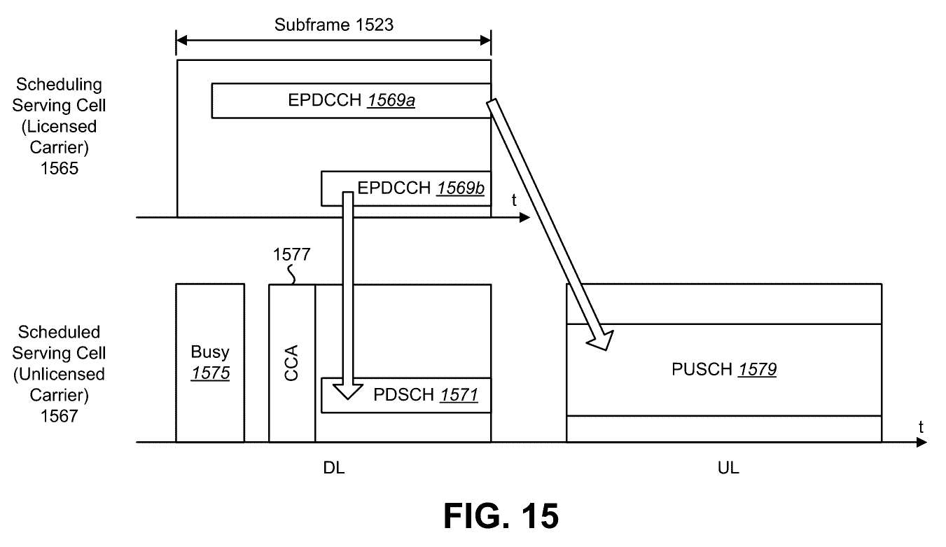

In another approach, EPDCCH search spaces (or EPDCCH PRB set) for the UL grant may be defined (or configured) independently of those for the DL assignment. This may be accomplished as illustrated in FIG. 15.

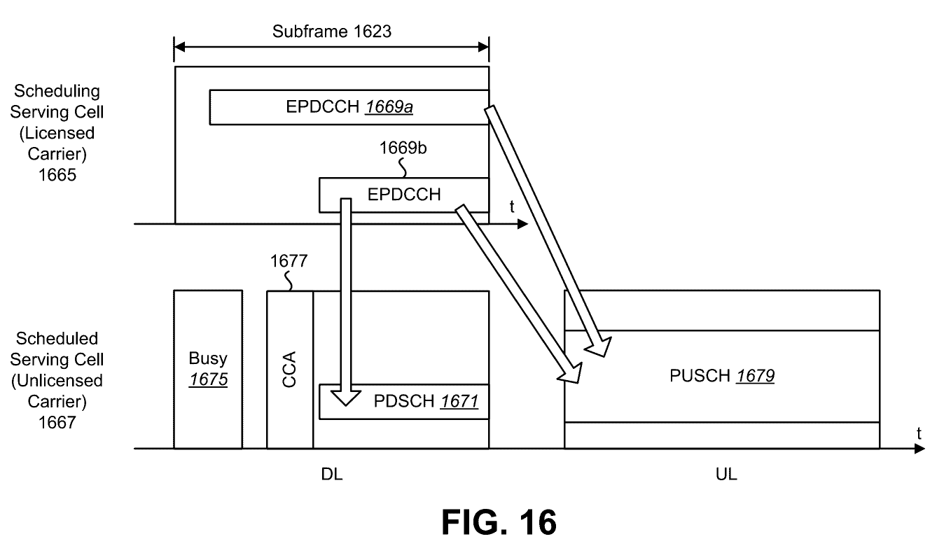

In yet another approach, the EPDCCH search spaces (or the EPDCCH PRB set) for the UL grant may be defined (or configured) either independently of those for the DL assignment or may be shared by DL assignment and UL grant. This may be accomplished as described in connection with FIG. 16.

For the EPDCCH search spaces (or the EPDCCH PRB set) of which the EPDCCH starting position is based on either CFI or a dedicated Radio Resource Control (RRC) message may be used only for the UL grant. On the other hand, the EPDCCH search spaces (or the EPDCCH PRB set) of which the EPDCCH starting position is derived by either one of the above options may be shared by the UL grant and the DL assignment. Moreover, the above-described EPDCCH structure (EPDCCH structure for a non-LAA cell) may be applied for the EPDCCH carrying the UL grant while the new EPDCCH structure may be applied for both the EPDCCH carrying the DL assignment and that carrying the UL grant. Note that the DL assignment corresponds to DCI format 1A/1B/1D/1/2A/2/2B/2C/2D and the UL grant corresponds to DCI format 0/4/5.

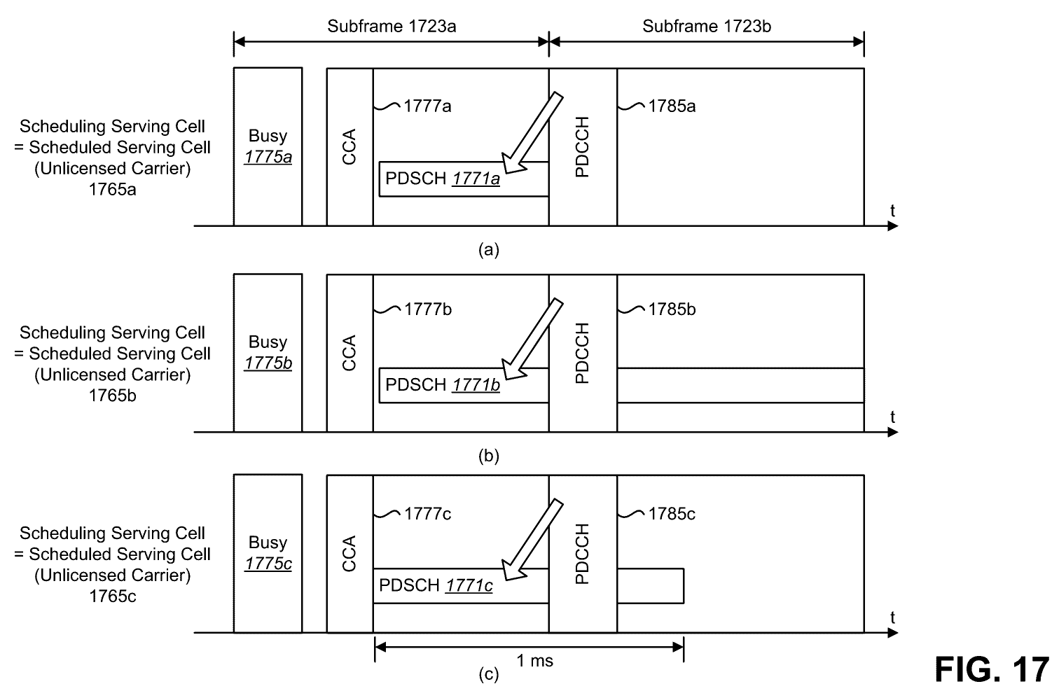

In another implementation, self- and cross-carrier scheduling for LAA SCell may be based on the PDCCH. Unlike the EPDCCH, it may be preferable that a PDCCH mapping rule is unified, since CRS may be transmitted together with the PDCCH for demodulation of the PDCCH. However, the PDCCH might not be able to be transmitted in the subframe where CCA is performed, since the PDCCH may be located at the beginning part of a subframe. To solve this issue, the PDCCH in subframe i may carry the DL assignment for the PDSCH in subframe i−1. FIG. 17 shows some examples.

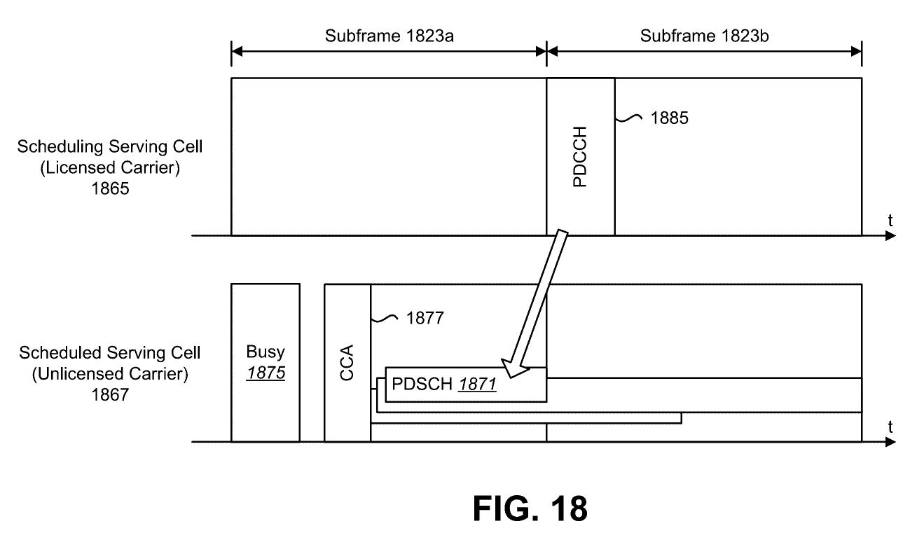

For cross-carrier scheduling for an LAA SCell, the PDCCH on the scheduling cell in subframe i may carry the DL assignment for the PDSCH on the scheduled cell in subframe i−1. As shown in FIG. 18, this principle can be applied regardless of the TTI type (i.e., cases (a) to (c)) in FIG. 17.

In the downlink, the OFDM access scheme may be employed. In the downlink, PDCCH, EPDCCH, PDSCH and the like may be transmitted. A downlink radio frame may consist of multiple pairs of downlink resource blocks (RBs). The downlink RB pair is a unit for assigning downlink radio resources, defined by a predetermined bandwidth (RB bandwidth) and a time slot. Two slots (i.e., slot0 and slot1) equal one subframe. The downlink RB pair consists of two downlink RBs that are continuous in the time domain.

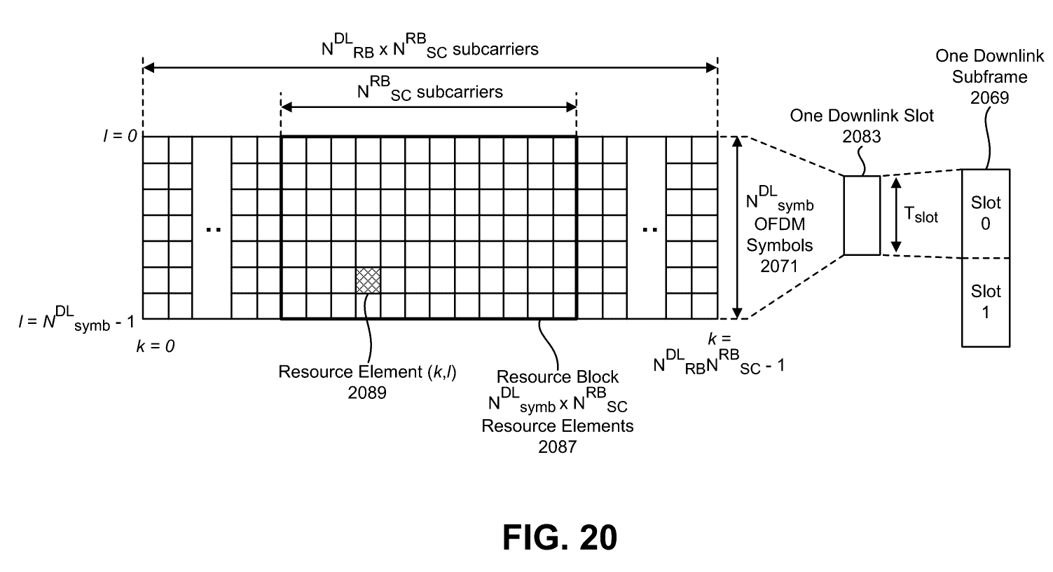

The downlink RB consists of twelve sub-carriers in frequency domain and seven (for normal CP) or six (for extended CP) OFDM symbols in time domain. A region defined by one sub-carrier in frequency domain and one OFDM symbol in time domain is referred to as a resource element (RE) and is uniquely identified by the index pair (k,l) in a slot, where k and l are indices in the frequency and time domains, respectively. While downlink subframes in one component carrier (CC) are discussed herein, downlink subframes are defined for each CC and downlink subframes are substantially in synchronization with each other among CCs. An example of a resource grid is discussed in connection with FIG. 20.

In Carrier Aggregation (CA), two or more CCs may be aggregated to support wider transmission bandwidths (e.g., up to 100 MHz, beyond 100 MHz). A UE 102 may simultaneously receive or transmit on one or multiple CCs. Serving cells can be classified into a primary cell (PCell) and a secondary cell (SCell).

The Primary Cell may be the cell, operating on the primary frequency, in which the UE 102 either performs the initial connection establishment procedure or initiates the connection re-establishment procedure, or the cell indicated as the primary cell in the handover procedure. The Secondary Cell may be a cell, operating on a secondary frequency, which may be configured once an RRC connection is established and which may be used to provide additional radio resources.

In the downlink, the carrier corresponding to the PCell is the downlink primary component carrier (DL PCC) while in the uplink it is the uplink primary component carrier (UL PCC). Similarly, in the downlink, the carrier corresponding to the SCell is the downlink secondary component carrier (DL SCC) while in the uplink it is the uplink secondary component carrier (UL SCC). The UE 102 may apply a system information acquisition (i.e., acquisition of broadcast system information) and change monitoring procedures for the PCell. For an SCell, E-UTRAN may provide, via dedicated signaling, all system information relevant for operation in an RRC_CONNECTED message when adding the SCell.

A downlink physical channel may correspond to a set of resource elements carrying information originating from higher layers. The following downlink physical channels may be defined. A physical downlink shared channel (PDSCH) may carry a transport block provided by a higher layer. The transport block may contain user data, higher layer control messages, physical layer system information. The scheduling assignment of PDSCH in a given subframe may normally be carried by PDCCH or EPDCCH in the same subframe.

A physical broadcast channel (PBCH) may carry a master information block, which is required for an initial access.

A physical multicast channel (PMCH) may carry MBMS related data and control information.

A physical control format indicator channel (PCFICH) may carry a control format indicator (CFI) specifying the number of OFDM symbols on which PDCCHs are mapped.

A physical downlink control channel (PDCCH) may carry a scheduling assignment (also referred to as a DL grant) or an UL grant. The PDCCH may be transmitted via the same antenna port (e.g., CRS port) as the PBCH.

A physical hybrid ARQ indicator channel (PHICH) may carry UL-associated HARQ-ACK information.

An enhanced physical downlink control channel (EPDCCH) may carry a scheduling assignment or an UL grant. The EPDCCH may be transmitted via a different antenna port (e.g., DM-RS port) from the PBCH and PDCCH. Possible REs on which EPDCCHs are mapped may be different from those for PDCCH, though they may partially overlap.

A downlink physical signal may correspond to a set of resource elements used by the physical layer but may not carry information originating from higher layers.

A cell-specific reference signal (CRS) may be assumed to be transmitted in all downlink subframes and DwPTS. For a normal subframe with normal CP, a CRS may be mapped on REs that are located in the 1st, 2nd, and 5th OFDM symbols in each slot. A CRS may be used for demodulation of the PDSCH, CSI measurement and RRM measurement.

A CSI-RS may be transmitted in the subframes that are configured by higher layer signaling. The REs on which a CSI-RS is mapped are also configured by higher layer signaling. A CSI-RS may be further classified into non zero power (NZP) CSI-RS and ZP (zero power) CSI-RS. A part of a ZP CSI-RS resources may be configured as a CSI-IM resource, which may be used for interference measurement.

A UE-specific RS (UE-RS) may be assumed to be transmitted in PRB pairs that are allocated for the PDSCH intended to the UE 102. UE-RS may be used for demodulation of the associated PDSCH.

A Demodulation RS (DM-RS) may be assumed to be transmitted in PRB pairs that are allocated for EPDCCH transmission. DM-RS may be used for demodulation of the associated EPDCCH.

Primary/secondary synchronization signals may be transmitted to facilitate the UE's 102 cell search, which is the procedure by which the UE 102 acquires time and frequency synchronization with a cell and detects the physical layer Cell ID of that cell. E-UTRA cell search supports a scalable overall transmission bandwidth corresponding to 6 resource blocks and upwards.

A discovery signal may consist of CRS, primary/secondary synchronization signals NZP-CSI-RS (if configured). The UE 102 may assume a discovery signal occasion once every DMTC-Periodicity. The eNB 160 using cell on/off may adaptively turn the downlink transmission of a cell on and off. A cell whose downlink transmission is turned off may be configured as a deactivated SCell for a UE 102. A cell performing on/off may transmit only periodic discovery signals and UEs 102 may be configured to measure the discovery signals for RRM. A UE 102 may perform RRM measurement and may discover a cell or transmission point of a cell based on discovery signals when the UE 102 is configured with discovery-signal-based measurements.

In Rel-12, there are ten transmission modes. These transmission modes may be configurable for an LAA SCell. These transmission modes are illustrated in Table (3).

TABLE 3

| Trans- | | |
|---|---|---|
| mission | | |
| mode | DCI format | Transmission scheme |
| Mode 1 | DCI format 1A | Single antenna port |
| | DCI format 1 | Single antenna port |
| Mode 2 | DCI format 1A | Transmit diversity |
| | DCI format 1 | Transmit diversity |
| Mode 3 | DCI format 1A | Transmit diversity |
| | DCI format 2A | Large delay CDD or Transmit diversity |
| Mode 4 | DCI format 1A | Transmit diversity |
| | DCI format 2 | Closed-loop spatial multiplexing or |
| | | Transmit diversity |
| Mode 5 | DCI format 1A | Transmit diversity |
| | DCI format 1D | Multi-user MIMO |
| Mode 6 | DCI format 1A | Transmit diversity |
| | DCI format 1B | Closed-loop spatial multiplexing using a |
| | | single transmission layer |
| Mode 7 | DCI format 1A | Single-antenna port (for a single CRS port), |
| | | transmit diversity (otherwise) |
| | DCI format 1 | Single-antenna port |
| Mode 8 | DCI format 1A | Single-antenna port (for a single CRS port), |
| | | transmit diversity (otherwise) |
| | DCI format 2B | Dual layer transmission or single-antenna port |
| Mode 9 | DCI format 1A | Single-antenna port (for a single CRS port or |
| | | MBSFN subframe), transmit diversity |
| | | (otherwise) |
| | DCI format 2C | Up to 8 layer transmission or single- |
| | | antenna port |
| Mode 10 | DCI format 1A | Single-antenna port (for a single CRS port or |
| | | MBSFN subframe), transmit diversity |
| | | (otherwise) |
| | DCI format 2D | Up to 8 layer transmission or single- |
| | | antenna port |

In Release-12, there are 16 kinds of DCI formats. DCI format 1, 1A, 1B, 1C, 1D, 2, 2A, 2B, 2C, and 2D may be used for DL assignment (also referred to as DL grant). DCI format 0 and 4 may be used for UL assignment (also referred to as UL grant). DCI format 3 and 3A may be used for UL TPC. DCI format 5 may be used for Sidelink scheduling.

DCI format 1A, 3 and 3A may have the same size as DCI format 0. Therefore, a UE 102 may be able to check the presence of DCI format 1A, 3 and 3A when the UE 102 decodes DCI format 0. The DCI formats are illustrated in Table (4).

TABLE 4

| DCI format | Use |
|---|---|
| DCI format 0 | scheduling of PUSCH in one UL cell |
| DCI format 1 | scheduling of one PDSCH codeword in one cell |
| DCI format 1A | compact scheduling of one PDSCH codeword in one |
| | cell and random access procedure initiated by a |
| | PDCCH order |
| DCI format 1B | compact scheduling of one PDSCH codeword in one |
| | cell with precoding information |
| DCI format 1C | very compact scheduling of one PDSCH codeword, |
| | notifying MCCH change, and reconfiguring TDD |
| DCI format 1D | compact scheduling of one PDSCH codeword in one |
| | cell with precoding and power offset information |
| DCI format 1A | Transmit diversity |
| DCI format 2 | scheduling of up to two PDSCH codewords in one |
| | cell with precoding information |
| DCI format 2A | scheduling of up to two PDSCH codewords in one cell |
| DCI format 2B | scheduling of up to two PDSCH codewords in one cell |
| | with scrambling identity information |
| DCI format 2C | scheduling of up to two PDSCH codewords in one cell |
| | with antenna port, scrambling identity and number |
| | of layers information |
| DCI format 2D | scheduling of up to two PDSCH codewords in |
| | one cell with antenna port, scrambling |
| | identity and number of layers information |
| | and PDSCH RE Mapping and Quasi-Co-Location |
| | Indicator (PQI) information |
| DCI format 3 | transmission of TPC commands for PUCCH and |
| | PUSCH with 2-bit power adjustments |
| DCI format 3A | transmission of TPC commands for PUCCH and |
| | PUSCH with single bit power adjustments |
| DCI format 4 | of PUSCH in one UL cell with multi-antenna port |
| | transmission mode |
| DCI format 5 | scheduling of PSCCH, and also contains several SCI |
| | format 0 fields used for the scheduling of PSSCH |

Carrier indicator field (CIF) may be present in some DCI formats carried by PDCCH/EPDCCH. CIF may indicate which serving cell's PDSCH/PUSCH the associated PDCCH/EPDCCH assigns. If CIF is configured, CIF may also be used for deriving UE-specific search space in which the UE 102 monitors the associated PDCCH/EPDCCH. The CIF may not be present in any PDCCH of the serving cell in the common search space. Upon the CIF configuration, UE 102 may have to assume that for the given serving cell the carrier indicator field is present in PDCCH/EPDCCH located in the UE 102 specific search space.

A UE 102 configured to monitor PDCCH candidates in a given serving cell with a given DCI format size with CIF, and CRC scrambled by C-RNTI, where the PDCCH/EPDCCH candidates may have one or more possible values of CIF for the given DCI format size, may assume that a PDCCH/EPDCCH candidate with the given DCI format size may be transmitted in the given serving cell in any PDCCH/EPDCCH UE-specific search space corresponding to any of the possible values of CIF for the given DCI format size.

DCI format 1, 1A, 1B, 1C, 1D may include the bit fields provided in Table (5), where NDLRB is a downlink system band width of the serving cell, which is expressed in multiples of PRB (physical resource block) bandwidth.

TABLE 5

| | DCI | DCI | DCI | DCI | DCI |
|---|---|---|---|---|---|
| | F 1 | F 1A | F 1B | F 1C | F 1D |
| CIF | 0 or 3 | 0 or 3 | 0 or 3 | N/A | 0 or 3 |
| Flag for | N/A | 1 | N/A | N/A | N/A |
| format0/1A | | | | | |
| differentiation | | | | | |
| Localized/ | N/A | 1 | 1 | N/A | 1 |
| Distributed | | | | | |
| VRB | | | | | |
| assignment | | | | | |
| flag | | | | | |
| Resource | 1 | N/A | N/A | N/A | N/A |
| allocation | | | | | |
| header | | | | | |
| Gap | N/A | N/A | N/A | 0 | |
| value | | | | (N^{DL}_{RB} < | N/A |
| | | | | 50) or 1 | |
| | | | | (otherwise) | |
| Resource | * | ** | ** | *** | ** |
| block | | | | | |
| assignment | | | | | |
| Modulation | 5 | 5 | 5 | 5 | 5 |
| and | | | | | |
| coding | | | | | |
| scheme | | | | | |
| HARQ | 3 (FDD | 3 (FDD | 3 (FDD | N/A | 3 (FDD |
| process | PCell) or | PCell) or | PCell) or | | PCell) or |
| number | 4 (TDD | 4 (TDD | 4 (TDD | | 4 (TDD |
| | PCell) | PCell) | PCell) | | PCell) |
| New data | 1 | 1 | 1 | N/A | 1 |
| indicator | | | | | |
| Redundancy | 2 | 2 | 2 | N/A | 2 |
| version | | | | | |
| TPC | 2 | 2 | 2 | N/A | 2 |
| command | | | | | |
| for | | | | | |
| PUCCH | | | | | |
| Downlink | 0 (FDD | 0 (FDD | 0 (FDD | N/A | 0 (FDD |
| Assignment | PCell) | PCell) | PCell) | | PCell) |
| Index | or 2 | or 2 | or 2 | | or 2 |
| | (otherwise) | (otherwise) | (otherwise) | (otherwise) | (otherwise) |
| SRS | N/A | 0 or 1 | N/A | N/A | N/A |
| request | | | | | |
| Downlink | N/A | N/A | N/A | N/A | 1 |
| power | | | | | |
| offset | | | | | |
| TPMI | N/A | N/A | 2 (2 CRS | N/A | 2 (2 CRS |
| information | | | ports) or | | ports) or |
| for | | | 4 (4 CRS | | 4 (4 CRS |
| precoding | | | ports) | | ports) |
| HARQ- | 2 | 2 | 2 | N/A | 2 |
| ACK | (EPDCCH) | (EPDCCH) | (EPDCCH) | | (EPDCCH) |
| resource | or 0 | or 0 | or 0 | | or 0 |
| offset | (PDCCH) | (PDCCH) | (PDCCH) | | (PDCCH) |

It should be noted that * is ceil(N^{DL}_{RB}/P) bits, where P is determined from Table (6); ** is ceil(log₂(N^{DL}_{RB}(N^{DL}_{RB}+1)/2)) bits; and *** is ceil(log₂(floor(N^{DL}_{VRB,gap1}/N^{step}_{RB})(floor(N^{DL}_{VRB,gap1}/N^{step}_{RB})+1)/2)) bits, where N^{DL}_{vRB,gap1}=2*min(N_{gap},N^{DL}_{RB}−N_{gap}).

TABLE 6

| System BW | PRG size |
|---|---|
| N^{DL}_{RB} | P |
| <=10 | 1 |
| 11-26 | 2 |
| 27-63 | 3 |
| 64-110 | 4 |

TABLE 7

| System BW | |
|---|---|
| N^{DL}_{RB} | N^{step}_{RB} |
| 6-49 | 2 |
| 50-110 | 4 |

DCI format 2, 2A, 2B, 2C, 2D may include the bit fields provided in Table (8).

TABLE 8

| | DCI F 2 | DCI F 2A | DCI F 2B | DCI F 2C | DCI F 2D |
|---|---|---|---|---|---|
| CIF | 0 or 3 | 0 or 3 | 0 or 3 | 0 or 3 | 0 or 3 |
| Resource | 1 | 1 | 1 | 1 | 1 |
| allocation | | | | | |
| header | | | | | |
| Resource block | * | * | * | * | * |
| assignment | | | | | |
| TPC command | 2 | 2 | 2 | 2 | 2 |
| for PUCCH | | | | | |
| Downlink | 0 (FDD | 0 (FDD | 0 (FDD | 0 (FDD | 0 (FDD |
| Assignment | PCell) or 2 | PCell) or 2 | PCell) or 2 | PCell) or 2 | PCell) or 2 |
| Index | (otherwise) | (otherwise) | (otherwise) | (otherwise) | (otherwise) |
| HARQ process | 3 (FDD | 3 (FDD | 3 (FDD | 3 (FDD | 3 (FDD |
| number | PCell) or 4 | PCell) or 4 | PCell) or 4 | PCell) or 4 | PCell) or 4 |
| | (TDD | (TDD | (TDD | (TDD | (TDD |
| | PCell) | PCell) | PCell) | PCell) | PCell) |
| Scrambling | N/A | N/A | 1 | N/A | N/A |
| identity | | | | | |
| Antenna port, | N/A | N/A | N/A | 3 | 3 |
| scrambling | | | | | |
| identity and | | | | | |
| number of | | | | | |
| layers | | | | | |
| SRS request | N/A | N/A | 0 or 1 | 0 or 1 | N/A |
| Transport block | 1 | 1 | N/A | N/A | |
| to codeword | | | | | |
| swap flag | | | | | |
| Modulation and | 5 | 5 | 5 | 5 | 5 |
| coding scheme | | | | | |
| (TB1) | | | | | |
| New data | 1 | 1 | 1 | 1 | 1 |
| indicator (TB1) | | | | | |
| Redundancy | 2 | 2 | 2 | 2 | 2 |
| version (TB1) | | | | | |
| Modulation and | 5 | 5 | 5 | 5 | 5 |
| coding scheme | | | | | |
| (TB2) | | | | | |
| New data | 1 | 1 | 1 | 1 | 1 |
| indicator (TB2) | | | | | |
| Redundancy | 2 | 2 | 2 | 2 | 2 |
| version (TB2) | | | | | |
| PDSCH RE | N/A | N/A | N/A | N/A | 2 |
| Mapping and | | | | | |
| Quasi-Co- | | | | | |
| Location | | | | | |
| Indicator | | | | | |
| Precoding | 3 (2 CRS | 0 (2 CRS | N/A | N/A | N/A |
| information | ports) or 6 | ports) or 2 | | | |
| | (4 CRS | (4 CRS | | | |
| | ports) | ports) | | | |
| HARQ-ACK | 2 | 2 | 2 | 2 | 2 |
| resource offset | (EPDCCH) | (EPDCCH) | (EPDCCH) | (EPDCCH) | (EPDCCH) |
| | or 0 | or 0 | or 0 | or 0 | or 0 |
| | (PDCCH) | (PDCCH) | (PDCCH) | (PDCCH) | (PDCCH) |

DCI format 4 may include the following bit fields provided in Table (9).

TABLE 9

| | DCI F 0 | DCI F 2 |
|---|---|---|
| CIF | 0 or 3 | 0 or 3 |
| Flag for format0/1A | 1 | N/A |
| differentiation | | |
| Frequency hopping flag | 1 | N/A |
| Resource block assignment | **** | ***** |
| TPC command for PUSCH | 2 | 2 |
| Cyclic shift for DMRS | 3 | 3 |
| and OCC index | | |
| UL index | 2 (TDD conf. 0) or 0 | 2 (TDD conf. 0) or |
| | (otherwise) | 0 (otherwise) |
| Downlink Assignment | 0 (TDD PCell) or 2 | 0 (TDD PCell) or |
| Index | (otherwise) | 2 (otherwise) |
| CSI request | 2 (multiple DL cells, | 2 (multiple DL |
| | multiple CSI | cells, multiple CSI |
| | processes, multiple | processes, multiple |
| | subframe sets) or 1 | subframe sets) or 1 |
| | (otherwise) | (otherwise) |
| SRS request | 0 or 1 | 2 |
| Resource allocation type | 1 | 1 |
| Modulation and coding | 5 | 5 |
| scheme (TB1) | | |
| New data indicator (TB1) | 1 | 1 |
| Modulation and coding | N/A | 5 |
| scheme (TB2) | | |
| New data indicator (TB2) | N/A | 1 |
| Precoding information | N/A | 3 (2 CRS ports) or |
| | | 6 (4 CRS ports) |

It should be noted that in Table (9), **** is ceil(log₂(N^{UL}_{RB}(N^{UL}_{RB}+1)/2)) bits. Also, ***** is max(ceil(log₂(N^{UL}_{RB}(N^{UL}_{RB}+1)/2)), ceil(log₂(C(ceil(N^{UL}_{RB}/P+1), 4)))) bits, where C(n, r) is the formula for combinations (i.e., “n choose r”).

The scheduling method may be enhanced for not only the above new EPDCCH structure but also conventional PDCCH/EPDCCH structure. In the normal CA operation, a parameter set related to cross-carrier scheduling is configured per SCell. The parameter set “CrossCarrierSchedulingConfig” may include either one of “own” information and “other” information, if the parameter set is configured. The “own” information may include “cif-presence” information for indicating whether or not the carrier indicator field (CIF) is present in PDCCH/EPDCCH DCI formats transmitted on the concerned serving cell. The “other” information may also include “scheduling cell ID” information for indicating which cell signals the downlink allocations and uplink grants, if applicable, for the concerned SCell. If the “other” information is included, the cross-carrier scheduling for the SCell may be activated. Otherwise, it is not activated (i.e., self-scheduling applies for the SCell).

For an LAA SCell configuration, the above parameter set may be used. Alternatively, some part could be changed. Several implementations are listed below. It should be noted that each of the following implementations may be able to be adopted independently and some of them may be able to be adopted at the same time.

In a first implementation, the parameter set for LAA SCell may include the “other” information but not the “own” information. This causes that CIF is not present in PDCCH/EPDCCH DCI formats on LAA SCells. This may also mean PDCCH/EPDCCH on LAA SCell is not available for scheduling another serving cell. A non-LAA SCell may follow the normal CA operation described above.

In a second implementation, if the “scheduling cell ID” is configured for the LAA SCell, the cross carrier scheduling from the configured scheduling cell may apply to DCI format 0/1A and 4 for the LAA SCell. Self-scheduling may apply to the other DCI formats (i.e., DCI format 1, 1B, 1C, 1D, 2, 2A, 2B, 2C and 2D) for the LAA SCell. A non-LAA SCell may follow the normal CA operation described above.

In an example, the parameter set “CrossCarrierSchedulingConfig” for Serving cell 1 (i.e., an LAA cell) includes “scheduling cell ID” information indicating Serving cell 2's cell index. DCI format 1, 1B, 1C, 1D, 2, 2A, 2B, 2C and 2D, which schedule PDSCH on Serving cell 1, may be transmitted in Serving cell 1 (i.e., self-scheduling but not following “CrossCarrierSchedulingConfig”). On the other hand, DCI format 1A scheduling PDSCH on Serving cell 1 may be transmitted in Serving cell 2 (i.e., following “CrossCarrierSchedulingConfig”). Also, DCI format 0 or 4 scheduling PUSCH on Serving cell 1 may be transmitted in Serving cell 2 (i.e., following “CrossCarrierSchedulingConfig”). A UE 102 configured with “CrossCarrierSchedulingConfig” for Serving cell 1 may monitor DCI format 0/1A and 4 on Serving cell 2 and DCI format 1, 1B, 1C, 1D, 2, 2A, 2B, 2C and 2D on Serving cell 1.

In this implementation, the monitoring of DCI format 0/1A and 4 may be able to be deactivated. The deactivation may be configured by dedicated RRC message. In one approach, the activation/deactivation may be configured per SCell. The UE 102 configured with the deactivation of monitoring of DCI format 0/1A and 4 for an given SCell might not have to monitor DCI format 1A scheduling PDSCH on the concerned SCell or DCI format 0 and 4 scheduling PUSCH on the concerned SCell.

In a third implementation, the “other” information may also include additional “scheduling cell ID” information (referred to as “scheduling cell ID2” hereafter). If the additional “scheduling cell ID” information is not configured (e.g., not included in “CrossCarrierSchedulingConfig”), the UE 102 and eNB 160 procedure may follow the above second implementation. If configured, DCI format 1, 1B, 1C, 1D, 2, 2A, 2B, 2C and 2D, which schedule PDSCH on Serving cell 1, are transmitted in Serving cell 3 whose cell index corresponds to “scheduling cell ID2”, instead of Serving cell 1. Here, Serving cell 3 could be different from Serving cell 2. Alternatively, Serving cell 3 could be the same as Serving cell 2.

Configuration of “scheduling cell ID2” may be independent from the configuration of “scheduling cell ID.” The “CrossCarrierSchedulingConfig” may include both “scheduling cell ID” and “scheduling cell ID2” or may include either one of them. The configuration of “scheduling cell ID” may be valid only when monitoring of DCI format 0/1A and 4 is activated (i.e., not deactivated).

In a fourth implementation, if the “scheduling cell ID” is configured for the LAA SCell, the cross carrier scheduling from the configured scheduling cell may apply to DCI format DCI format 1, 1B, 1C, 1D, 2, 2A, 2B, 2C and 2D for the LAA SCell. Self-scheduling may apply to the other DCI formats (i.e., DCI format 0/1A and 4) for the LAA SCell. A non-LAA SCell may follow the normal CA operation described above.

In an example, the parameter set “CrossCarrierSchedulingConfig” for Serving cell 1 (LAA cell) may include “scheduling cell ID” information indicating Serving cell 2's cell index. In this case, DCI format 1, 1B, 1C, 1D, 2, 2A, 2B, 2C and 2D, which schedule PDSCH on Serving cell 1, may be transmitted in Serving cell 2 (i.e., following “CrossCarrierSchedulingConfig”). On the other hand, DCI format 1A scheduling PDSCH on Serving cell 1 may be transmitted in Serving cell 1 (i.e., self-scheduling but not following “CrossCarrierSchedulingConfig”). Also, DCI format 0 or 4 scheduling PUSCH on Serving cell 1 may be transmitted in Serving cell 1 (i.e., self-scheduling but not following “CrossCarrierSchedulingConfig”). A UE 102 configured with “CrossCarrierSchedulingConfig” for Serving cell 1 may monitor DCI format 0/1A and 4 on Serving cell 1 and DCI format 1, 1B, 1C, 1D, 2, 2A, 2B, 2C and 2D on Serving cell 2.

In this implementation, monitoring of DCI format 0/1A and 4 may be able to be deactivated. The deactivation may be configured by dedicated RRC message. In one approach, the activation/deactivation may be configured per SCell. The UE 102 configured with the deactivation of monitoring of DCI format 0/1A and 4 for an given SCell might not have to monitor DCI format 1A scheduling PDSCH on the concerned SCell or DCI format 0 and 4 scheduling PUSCH on the concerned SCell.

In a fifth implementation, the “other” information may also include additional “scheduling cell ID” information (referred to as “scheduling cell ID2” hereafter). If the additional “scheduling cell ID” information is not configured (e.g., not included in “CrossCarrierSchedulingConfig”), the UE 102 and eNB 160 procedure may follow the above fourth implementation.

If configured, DCI format 0/1A and 4, which schedule PDSCH or PUSCH on Serving cell 1, may be transmitted in Serving cell 3 whose cell index corresponds to “scheduling cell ID2”, instead of Serving cell 1. Here, Serving cell 3 could be different from Serving cell 2. Alternatively, Serving cell 3 could be the same as Serving cell 2. “CrossCarrierSchedulingConfig” may include both of them or may include either one of them. The configuration of “scheduling cell ID2” may be valid only when monitoring of DCI format 0/1A and 4 is activated (i.e., not deactivated).

In a sixth implementation, in the normal CA operation the “cif-presence” information applies all DCI formats transmitted on the concerned serving cell. The parameter set for LAA SCell may include additional “cif-presence” information (referred to as “cif-presence 2” hereafter). In this case, the “cif-presence” information may indicate whether or not CIF is present in PDCCH/EPDCCH DCI formats 1, 1B, 1D, 2, 2A, 2B, 2C and 2D transmitted on the concerned serving cell, while the “cif-presence 2” information may indicate whether or not CIF is present in PDCCH/EPDCCH DCI formats 0/1A and 4 transmitted on the concerned serving cell, or vice versa.

It should be noted that the UE 102 may monitor DCI format 0 and 4 only if the scheduled serving cell has UL resources. The UE 102 may not have to monitor DCI format 0 and 4 if the scheduled serving cell has only DL resources. In addition, the UE 102 may monitor DCI format 4 only if the UE 102 is configured with monitoring of DCI format 4 via dedicated RRC message. The UE 102 may not have to monitor DCI format 4 if the UE 102 is not configured with DCI format 4. Also note that PDCCH and EPDCCH may be monitored in non-DRX subframes.

The UE operations module 124 may provide information 148 to the one or more receivers 120. For example, the UE operations module 124 may inform the receiver(s) 120 when to receive retransmissions.

The UE operations module 124 may provide information 138 to the demodulator 114. For example, the UE operations module 124 may inform the demodulator 114 of a modulation pattern anticipated for transmissions from the eNB 160.

The UE operations module 124 may provide information 136 to the decoder 108. For example, the UE operations module 124 may inform the decoder 108 of an anticipated encoding for transmissions from the eNB 160.

The UE operations module 124 may provide information 142 to the encoder 150. The information 142 may include data to be encoded and/or instructions for encoding. For example, the UE operations module 124 may instruct the encoder 150 to encode transmission data 146 and/or other information 142. The other information 142 may include PDSCH HARQ-ACK information.

The encoder 150 may encode transmission data 146 and/or other information 142 provided by the UE operations module 124. For example, encoding the data 146 and/or other information 142 may involve error detection and/or correction coding, mapping data to space, time and/or frequency resources for transmission, multiplexing, etc. The encoder 150 may provide encoded data 152 to the modulator 154.

The UE operations module 124 may provide information 144 to the modulator 154. For example, the UE operations module 124 may inform the modulator 154 of a modulation type (e.g., constellation mapping) to be used for transmissions to the eNB 160. The modulator 154 may modulate the encoded data 152 to provide one or more modulated signals 156 to the one or more transmitters 158.

The UE operations module 124 may provide information 140 to the one or more transmitters 158. This information 140 may include instructions for the one or more transmitters 158. For example, the UE operations module 124 may instruct the one or more transmitters 158 when to transmit a signal to the eNB 160. For instance, the one or more transmitters 158 may transmit during a UL subframe. The one or more transmitters 158 may upconvert and transmit the modulated signal(s) 156 to one or more eNBs 160.

The eNB 160 may include one or more transceivers 176, one or more demodulators 172, one or more decoders 166, one or more encoders 109, one or more modulators 113, a data buffer 162 and an eNB operations module 182. For example, one or more reception and/or transmission paths may be implemented in an eNB 160. For convenience, only a single transceiver 176, decoder 166, demodulator 172, encoder 109 and modulator 113 are illustrated in the eNB 160, though multiple parallel elements (e.g., transceivers 176, decoders 166, demodulators 172, encoders 109 and modulators 113) may be implemented.

The transceiver 176 may include one or more receivers 178 and one or more transmitters 117. The one or more receivers 178 may receive signals from the UE 102 using one or more antennas 180a-n. For example, the receiver 178 may receive and downconvert signals to produce one or more received signals 174. The one or more received signals 174 may be provided to a demodulator 172. The one or more transmitters 117 may transmit signals to the UE 102 using one or more antennas 180a-n. For example, the one or more transmitters 117 may upconvert and transmit one or more modulated signals 115.

The demodulator 172 may demodulate the one or more received signals 174 to produce one or more demodulated signals 170. The one or more demodulated signals 170 may be provided to the decoder 166. The eNB 160 may use the decoder 166 to decode signals. The decoder 166 may produce one or more decoded signals 164, 168. For example, a first eNB-decoded signal 164 may comprise received payload data, which may be stored in a data buffer 162. A second eNB-decoded signal 168 may comprise overhead data and/or control data. For example, the second eNB-decoded signal 168 may provide data (e.g., PDSCH HARQ-ACK information) that may be used by the eNB operations module 182 to perform one or more operations.

In general, the eNB operations module 182 may enable the eNB 160 to communicate with the one or more UEs 102. The eNB operations module 182 may include one or more of an eNB (E)PDCCH-based PDSCH scheduling module 194.

The eNB (E)PDCCH-based PDSCH scheduling module 194 may transmit an RRC message for configuration of a first serving cell and an RRC message for configuration of a second serving cell as a scheduling cell for the first serving cell. This may be accomplished as described above.

The eNB (E)PDCCH-based PDSCH scheduling module 194 may transmit a physical downlink control channel (PDCCH), which schedules a physical downlink shared channel (PDSCH) in the first serving cell, on the first serving cell when a first DCI format is used. The eNB (E)PDCCH-based PDSCH scheduling module 194 may transmit the PDCCH, which schedules the PDSCH in the first serving cell, on the second serving cell when a second DCI format is used. This may be accomplished as described above.

The eNB operations module 182 may provide information 188 to the demodulator 172. For example, the eNB operations module 182 may inform the demodulator 172 of a modulation pattern anticipated for transmissions from the UE(s) 102.

The eNB operations module 182 may provide information 186 to the decoder 166. For example, the eNB operations module 182 may inform the decoder 166 of an anticipated encoding for transmissions from the UE(s) 102.

The eNB operations module 182 may provide information 101 to the encoder 109. The information 101 may include data to be encoded and/or instructions for encoding. For example, the eNB operations module 182 may instruct the encoder 109 to encode information 101, including transmission data 105.

The encoder 109 may encode transmission data 105 and/or other information included in the information 101 provided by the eNB operations module 182. For example, encoding the data 105 and/or other information included in the information 101 may involve error detection and/or correction coding, mapping data to space, time and/or frequency resources for transmission, multiplexing, etc. The encoder 109 may provide encoded data 111 to the modulator 113. The transmission data 105 may include network data to be relayed to the UE 102.

The eNB operations module 182 may provide information 103 to the modulator 113. This information 103 may include instructions for the modulator 113. For example, the eNB operations module 182 may inform the modulator 113 of a modulation type (e.g., constellation mapping) to be used for transmissions to the UE(s) 102. The modulator 113 may modulate the encoded data 111 to provide one or more modulated signals 115 to the one or more transmitters 117.

The eNB operations module 182 may provide information 192 to the one or more transmitters 117. This information 192 may include instructions for the one or more transmitters 117. For example, the eNB operations module 182 may instruct the one or more transmitters 117 when to (or when not to) transmit a signal to the UE(s) 102. In some implementations, this may be based on the PSS and SSS. The one or more transmitters 117 may upconvert and transmit the modulated signal(s) 115 to one or more UEs 102.

It should be noted that a DL subframe may be transmitted from the eNB 160 to one or more UEs 102 and that a UL subframe may be transmitted from one or more UEs 102 to the eNB 160. Furthermore, both the eNB 160 and the one or more UEs 102 may transmit data in a standard special subframe.

It should also be noted that one or more of the elements or parts thereof included in the eNB(s) 160 and UE(s) 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

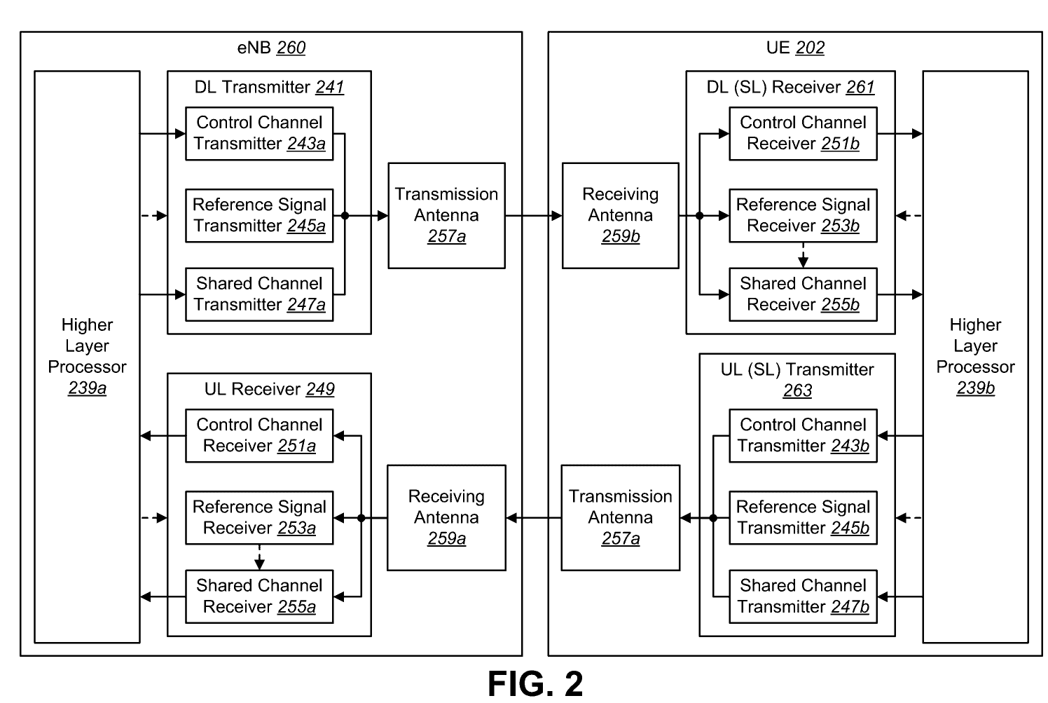

FIG. 2 is block diagram illustrating a detailed configuration of an eNB 260 and a UE 202 in which systems and methods for LAA may be implemented. The eNB 260 may include a higher layer processor 239a, a DL transmitter 241 and a UL receiver 249. The higher layer processor 239a may communicate with the DL transmitter 241, UL receiver 249 and subsystems of each.

The DL transmitter 241 may include a control channel transmitter 243a, a reference signal transmitter 245a and a shared channel transmitter 247a. The DL transmitter 241 may transmit signals/channels to the UE 202 using a transmission antenna 257a.

The UL receiver 249 may include a control channel receiver 251a, a reference signal receiver 253a and a shared channel receiver 255a. The UL receiver 249 may receive signals/channels from the UE 202 using a receiving antenna 259a. The reference signal receiver 253a may provide signals to the shared channel receiver 255a based on the received reference signals.

The eNB 260 may configure, in the UE 202, a first serving cell. The first serving cell may be an LAA cell. The eNB 260 may also configure, in the UE 202, a second serving cell as a scheduling cell for the first serving cell.

The eNB 260 may transmit a PDCCH that schedules a PDSCH on the first serving cell, on the first serving cell in case that the first DCI format is used in the PDCCH. The eNB 260 may transmit a PDCCH that schedules the PDSCH on the first serving cell, on the second serving cell in case that the second DCI format is used in the PDCCH.

The eNB 260 may further configure, in the UE 202, a third serving cell as another scheduling cell for the first serving cell. If the third serving cell is configured, the eNB 260 may transmit a PDCCH that schedules the PDSCH on the first serving cell on the third serving cell, instead of the first serving cell, in case that the first DCI format is used in the PDCCH.

The UE 202 may include a higher layer processor 239b, a DL (SL) receiver 261 and a UL (SL) transmitter 263. The higher layer processor 239b may communicate with the DL (SL) receiver 261, UL (SL) transmitter 263 and subsystems of each.

The DL (SL) receiver 261 may include a control channel receiver 251b, a reference signal receiver 253b and a shared channel receiver 255b. The DL (SL) receiver 261 may receive signals/channels from the UE 202 using a receiving antenna 259b. The reference signal receiver 253b may provide signals to the shared channel receiver 255b based on the received reference signals. For example, the shared channel receiver 255b may be configured to receive the PDSCH for which the same antenna port is used as for the reference signals.

The UL (SL) transmitter 263 may include a control channel transmitter 243b, a reference signal transmitter 245b and a shared channel transmitter 247b. The UL (SL) transmitter 263 may send signals/channels to the eNB 260 using a transmission antenna 257b.

The UE 202 may configure, based on a dedicated RRC message from the eNB 260, the SCG and a use of shortened TTI and/or shortened RTT on the SCG. The configurations may be performed by the higher layer processor 239b.

The UE 202 may configure, by the eNB 260, the first serving cell (e.g., the LAA cell). The UE 202 may also configure, by the eNB 260, the second serving cell as a scheduling cell for the first serving cell.

The UE 202 may monitor a PDCCH with the first DCI format, which schedules a PDSCH on the first serving cell, on the first serving cell. The UE 202 may monitor a PDCCH with the second DCI format, which schedules a PDSCH on the first serving cell, on the second serving cell.

The UE 202 may further configure, by the eNB 260, the third serving cell as another scheduling cell for the first serving cell. If the third serving cell is configured, the UE 202 may monitor the PDCCH with the first DCI format, which schedules the PDSCH on the first serving cell, on the third serving cell, instead of the first serving cell.

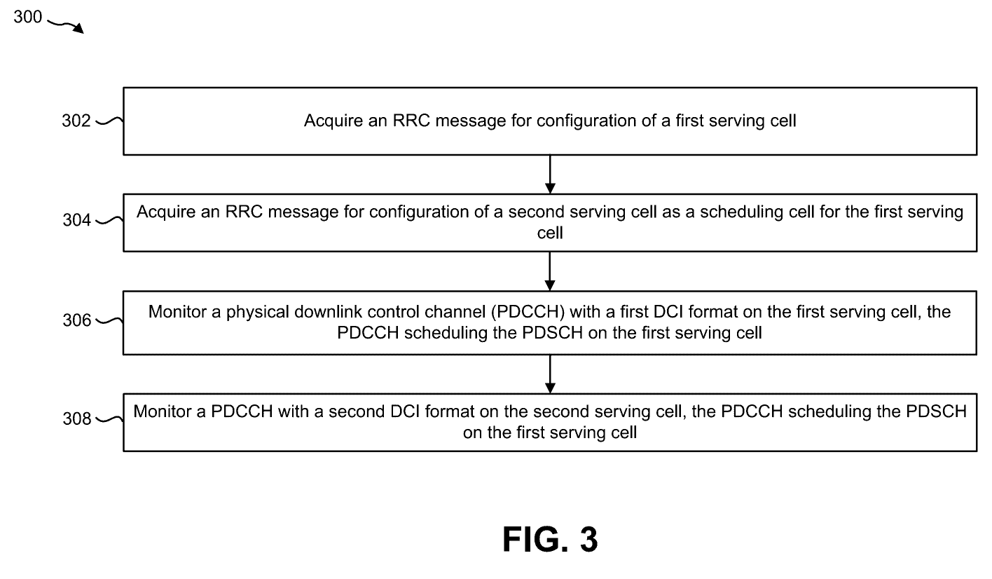

FIG. 3 is a flow diagram illustrating a method 300 for LAA by a UE 102. The UE 102 may acquire 302 an RRC message for configuration of a first serving cell. The first serving cell may be an LAA cell. The UE 102 may also acquire 304 an RRC message for configuration of a second serving cell as a scheduling cell for the first serving cell.

The UE 102 may monitor 306 a physical downlink control channel (PDCCH) with a first DCI format on the first serving cell. The PDCCH with the first DCI format may schedule a physical downlink shared channel (PDSCH) in the first serving cell.

The UE 102 may monitor 308 a PDCCH with a second DCI format on the second serving cell. The PDCCH with the second DCI format may schedule a PDSCH in the first serving cell.

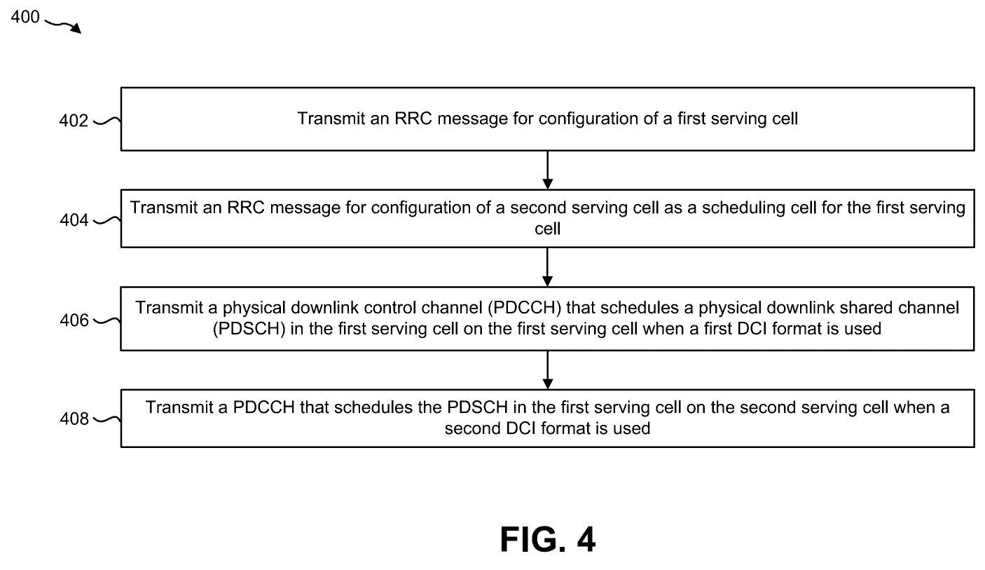

FIG. 4 is a flow diagram illustrating a method 400 for LAA by an eNB 160. The eNB 160 may transmit 402 an RRC message for configuration of a first serving cell. The first serving cell may be an LAA cell. The eNB 160 may also transmit 404 an RRC message for configuration of a second serving cell as a scheduling cell for the first serving cell.

The eNB 160 may transmit 406 a physical downlink control channel (PDCCH) that schedules a physical downlink shared channel (PDSCH) in the first serving cell on the first serving cell when a first DCI format is used.

The eNB 160 may transmit 408 a PDCCH that schedules the PDSCH in the first serving cell on the second serving cell when a second DCI format is used.

FIG. 5 is a block diagram illustrating an example of self-scheduling within a licensed carrier. A subframe 523 is shown with respect to time t. In this example of self-scheduling, the scheduling serving cell 565 is also the scheduled serving cell. The EPDCCH 569 of the serving cell schedules PDSCH 571 resources of that serving cell, as indicated by the arrow.

FIG. 6 is a block diagram illustrating an example of cross-carrier scheduling among licensed carriers. A subframe 623 is shown for both a scheduling serving cell 665 and a scheduled serving cell 667 with respect to time t. In this example of cross-carrier scheduling, both serving cells are licensed carriers.

Cross-carrier scheduling with the CIF may allow the (E)PDCCH of a serving cell to schedule resources on another serving cell. The EPDCCH 669 of the scheduling serving cell 665 schedules PDSCH 671 resources of the scheduled serving cell 667.

FIG. 7 illustrates an example of a first EREG/ECCE structure. In this example, there are 16 EREGs, numbered from 0 to 15, per PRB pair. The PRB bandwidth 773 for a subframe 723 is shown.

All resource elements, except resource elements carrying DM-RS for antenna ports 107-110 for normal cyclic prefix or 107-108 for extended cyclic prefix, are numbered in a physical resource-block pair cyclically from 0 to 15 in an increasing order of first frequency, then time. All resource elements with number i in that PRB pair constitute EREG number i.

The EPDCCH may carry scheduling assignments. An EPDCCH may be transmitted using an aggregation of one or several consecutive ECCEs. Each ECCE may include multiple EREGs. In one example, ECCE0 consists of EREG0, EREG4, EREG8 and EREG12. ECCE1 consists of EREG1, EREGS, EREG9 and EREG13. ECCE2 consists of EREG2, EREG6, EREG10 and EREG14. ECCE3 consists of EREG3, EREG7, EREG11 and EREG15. Eventually, one ECCE distributes within a PRB pair in time and frequency domain.

FIG. 8 is a block diagram illustrating an example of self-scheduling within an unlicensed carrier. A subframe 823 is shown with respect to time t. In this example of self-scheduling, the scheduling serving cell 865 is also the scheduled serving cell. The EPDCCH 869 of the serving cell schedules PDSCH 871 resources of that serving cell. In this example, the scheduling serving cell 865 may be an LAA SCell. In this case, the scheduling serving cell 865 may perform CCA 877 after a busy 875 period.

FIG. 9 illustrates an example of a second EREG/ECCE structure. The second EREG/ECCE structure may be used for an LAA SCell. The PRB bandwidth 973 for a subframe 923 is shown.

The resource elements in the first three OFDM symbols of the first slot (slot 0) in a physical resource-block pair may be numbered cyclically among {0, 4, 8, 12} in an increasing order of first frequency and then time. The resource elements, except resource elements carrying DM-RS for antenna ports 107-110 for normal cyclic prefix or 107-108 for extended cyclic prefix, in the remaining OFDM symbols of the first slot (slot 0) in a physical resource-block pair may be numbered cyclically among {1, 5, 9, 13} in an increasing order of first frequency and then time.

The resource elements in the first three OFDM symbols of the second slot (slot 1) in a physical resource-block pair may be numbered cyclically among {2, 6, 10, 14} in an increasing order of first frequency and then time. The resource elements, except resource elements carrying DM-RS for antenna ports 107-110 for normal cyclic prefix or 107-108 for extended cyclic prefix, in the remaining OFDM symbols of the second slot in a physical resource-block pair may be numbered cyclically among {3, 7, 11, 15} in an increasing order of first frequency and then time.

All resource elements with number i in that physical resource-block pair constitute EREG number i. EREG to ECCE mapping may be the same as the first EREG/ECCE structure, as described in connection with FIG. 7. In the new structure of FIG. 9, REs constituting each EREG/ECCE in a PRB pair get closer in time domain compared to the first EREG/ECCE structure.

In this example, ECCE0 consists of EREG0, EREG4, EREG8 and EREG12 that are located on OFDM symbol #0-#2 in Slot 0. ECCE1 consists of EREG1, EREGS, EREG9 and EREG13 that are located on OFDM symbol #3-#6 in Slot 0. ECCE2 consists of EREG2, EREG6, EREG10 and EREG14 that are located on OFDM symbol #0-#2 in Slot 1. ECCE3 consists of EREG3, EREG7, EREG11 and EREG15 that are located on OFDM symbol #3-#6 in Slot 1. In other words, the possible EPDCCH starting symbols l_{EPDCCHStart} could be OFDM symbol #0, #3, #7 and #10. Although FIG. 9 shows an example of EREG to ECCE mapping for localized transmission, the same mapping between ECCE indices and EREG indices may be applied to a distributed transmission except that EREGs in different PRBs constitute an ECCE.

Eventually, one ECCE distributes within a PRB pair in frequency domain but is concentrated in time domain. The DMRS in Slot 0 may be used only for demodulation of EPDCCH consisting of EREG/ECCE mapped in Slot 0. The DMRS in Slot 1 may be used only for demodulation of EPDCCH consisting of EREG/ECCE mapped in Slot 1. Alternatively, the DMRS in Slot 1 may also be used for demodulation of EPDCCH consisting of EREG/ECCE mapped in Slot 0.

The new EREG/ECCE structure may be applied based on higher-layer configuration. An RRC message for EPDCCH configuration may have a field for indicating whether or not the new EREG/ECCE structure is used. Alternatively, whether or not the new EREG/ECCE structure is used may depend on whether or not the scheduled cell is an LAA cell. In this instance, the new EREG/ECCE structure is used if the scheduled cell is an LAA cell. Otherwise, the existing EREG/ECCE structure (e.g., the first EREG/ECCE structure for non-LAA cell of FIG. 7) may be used.

FIGS. 10A and 10B show examples of ECCE aggregation according to the second ECCE structure. As described above, an EPDCCH may be transmitted using an aggregation of one or several consecutive ECCEs. Each of the dashed boxes in FIGS. 10A and 10B show an example of an ECCE set (a set of aggregated ECCEs), each of which constitutes a single EPDCCH.

In a first aggregation 1075a (aggregation level=1), the ECCE of PRB4 is used by itself. In a second aggregation 1075b (aggregation level=2), the ECCEs of PRB4 and PRB3 are aggregated. In a third aggregation 1075c (aggregation level=3), the ECCEs of PRB4, PRB3 and PRB2 are aggregated. In a fourth aggregation 1075d (aggregation level=4), the ECCEs of PRB4, PRB3, PRB2 and PRB1 are aggregated.

Even when aggregated, ECCEs constituting an EPDCCH are localized in time domain. To be more specific, a single EPDCCH may consist of multiple ECCEs that are mapped on the same set of OFDM symbols (e.g. 3 or 4 consecutive OFDM symbols) of a subframe in the different PRB pairs.

According to this, the eNB 160 can schedule the EPDCCH assignment considering the LBT result. Furthermore, each EPDCCH candidate with the same aggregation level 1075 has almost the same number of available REs. This makes the eNB's EPDCCH coding rate determination procedure easier.

FIG. 11 is a block diagram illustrating an example of cross-carrier scheduling for LAA carriers. A subframe 1123 is shown for both a scheduling serving cell 1165 and a scheduled serving cell 1167 with respect to time t. In this example of cross-carrier scheduling, the scheduling serving cell 1165 is a licensed carrier and the scheduled serving cell 1167 is an unlicensed carrier (e.g., LAA cell).

For cross-carrier scheduling for the LAA SCell, scheduling of the EPDCCH 1169b in the non-LAA serving cell may start after ensuring the clear channel on the LAA SCell (e.g., after the busy period 1175 and performing CCA 1177). The EPDCCH 1169b of the non-LAA serving cell 1165 schedules PDSCH 1171b resources of the LAA SCell cell 1167. Therefore, the above-described EPDCCH mapping on the LAA SCell can be used for an EPDCCH cross-carrier scheduling of resources on the LAA SCell. Meanwhile, a self-scheduling EPDCCH 1169a and PDSCH 1171a in the non-LAA serving cell 1165 may start independently of the LBT on the LAA SCell 1167.

FIG. 12 is a block diagram illustrating an example of search space sharing among scheduled serving cells 1267. A subframe 1223 is shown for both a scheduling serving cell 1265 and a scheduled serving cell 1267 with respect to time t. In this example of cross-carrier scheduling, the scheduling serving cell 1265 is a licensed carrier and the scheduled serving cell 1267 is an unlicensed carrier (e.g., LAA cell). LBT may be performed in the subframe 1223 on the scheduled serving cell 1267 (i.e., the LAA SCell). In this example, CCA 1277 follows a busy 1275 period.

For cross-carrier scheduling for the LAA SCell 1267, scheduling of the EPDCCH 1269b in the non-LAA serving cell 1265 may start after ensuring the clear channel on the LAA SCell 1267 (e.g., after the busy period 1275 and performing CCA 1277). The EPDCCH 1269b of the non-LAA serving cell 1265 schedules PDSCH 1271b resources of the LAA SCell 1267. Meanwhile, a self-scheduling EPDCCH 1269a and PDSCH 1271a in the non-LAA serving cell 1265 may start independently of the LBT on the LAA SCell 1267.

If the UE 102 is configured with CIF and if the DCI format size is the same, search space for the EPDCCH scheduling resources on the LAA SCell may be used also for self-scheduling. More specifically, the eNB 160 may transmit the EPDCCH 1269b for the non-LAA cell 1265 using the search space for the EPDCCH for the LAA cell 1267. The UE 102 may monitor a set of EPDCCH candidates on one or more activated serving cells as configured by higher layer signaling for control information, where monitoring implies attempting to decode each of the EPDCCHs in the set according to the monitored DCI formats. The set of EPDCCH candidates to monitor are defined in terms of EPDCCH UE-specific search spaces.

In the implementation of FIG. 12, the UE 102 may monitor the EPDCCH 1169b for the non-LAA cell 1165 on a search space for the EPDCCH for the LAA cell. In one case, UE 102 may be configured to monitor EPDCCH candidates in a given serving cell with a given DCI format size with CIF, and CRC scrambled by C-RNTI, where the EPDCCH candidates may have one or more possible values of CIF for the given DCI format size and the EPDCCH starting position is based on either epdcch-StartSymbol-r11, pdsch-Start-r11 or CFI value. In this case, the UE 102 may assume that an EPDCCH candidate with the given DCI format size is transmitted in the given serving cell in any EPDCCH UE-specific search space corresponding to any of the possible values of CIF, except for the CIF corresponding to LAA serving cell, for the given DCI format size.

In another case, a UE 102 may be configured to monitor EPDCCH candidates in a given serving cell with a given DCI format size with CIF, and CRC scrambled by C-RNTI, where the EPDCCH candidates may have one or more possible values of CIF for the given DCI format size and the EPDCCH starting position is not based on either epdcch-StartSymbol-r11, pdsch-Start-r11 or CFI value. In this case, the UE 102 may assume that an EPDCCH candidate with the given DCI format size is transmitted in the given serving cell in any EPDCCH UE-specific search space corresponding to any of the possible values of CIF for the given DCI format size.

FIG. 13 is a block diagram illustrating another example of search space sharing among scheduled serving cells. A subframe 1323 is shown for both a scheduling serving cell 1365, a scheduled serving cell 1367a of a licensed carrier and a scheduled serving cell 1367b of an unlicensed carrier (e.g., LAA cell) with respect to time t. In this example of cross-carrier scheduling, the scheduling serving cell 1365 is a licensed carrier (e.g., non-LAA cell). LBT may be performed in the subframe 1323 on the unlicensed scheduled serving cell 1367b (i.e., the LAA SCell). In this example, CCA 1377 follows a busy 1375 period.

For cross-carrier scheduling for the LAA scheduled serving cell 1367b, scheduling of the EPDCCH 1369b in the non-LAA scheduling serving cell 1365 may start after ensuring the clear channel on the LAA scheduled serving cell 1367b (e.g., after the busy period 1375 and performing CCA 1377). The EPDCCH 1369b of the non-LAA scheduling serving cell 1365 schedules PDSCH 1371b resources of the LAA scheduled serving cell 1367. Meanwhile, a self-scheduling EPDCCH 1369a and PDSCH 1371a in the non-LAA scheduling serving cell 1365 may start independently of the LBT on the LAA scheduled serving cell 1367b. The EPDCCH 1369a of the non-LAA scheduling serving cell 1365 may schedule PDSCH 1371c resources of the non-LAA scheduled serving cell 1367a.

In the implementation of FIG. 13, even if the UE 102 is configured with CIF and the DCI format size is the same, the search space for the EPDCCH scheduling resources on the SCell may not be used for self-scheduling if the SCell is an LAA cell. More specifically, the eNB 160 may not transmit the EPDCCH for the non-LAA cell using the search space for the EPDCCH for the LAA cell while the eNB 160 may transmit the EPDCCH for the non-LAA cell using the search space for the EPDCCH for another non-LAA cell. The UE 102 may not monitor the EPDCCH for the non-LAA cell on the search space for the EPDCCH for the LAA cell while the UE 102 may monitor the EPDCCH for the non-LAA cell on the search space for the EPDCCH for another non-LAA cell.

In one case, a UE 102 may be configured to monitor EPDCCH candidates in a given serving cell with a given DCI format size with CIF, and CRC scrambled by C-RNTI, where the EPDCCH candidates may have one or more possible values of CIF for the given DCI format size and the EPDCCH starting position is based on either epdcch-StartSymbol-r11, pdsch-Start-r11 or CFI value. In this case, the UE 102 may assume that an EPDCCH candidate with the given DCI format size is transmitted in the given serving cell in any EPDCCH UE-specific search space corresponding to any of the possible values of CIF, except for the CIF corresponding to LAA serving cell, for the given DCI format size.

In another case, a UE 102 configured to monitor EPDCCH candidates in a given serving cell with a given DCI format size with CIF, and CRC scrambled by C-RNTI, where the EPDCCH candidates may have one or more possible values of CIF for the given DCI format size and the EPDCCH starting position is not based on either epdcch-StartSymbol-r11, pdsch-Start-r11 or CFI value. In this case, the UE 102 may assume that an EPDCCH candidate with the given DCI format size is transmitted in the given serving cell in any EPDCCH UE-specific search space corresponding to any of the possible values of CIF corresponding to LAA serving for the given DCI format size.

FIG. 14 is a block diagram illustrating an example of search space sharing for DL assignment and UL grant. A DL subframe 1423 is shown for both a scheduling serving cell 1465 and a scheduled serving cell 1467 with respect to time t. An UL subframe is also shown for the scheduled serving cell 1467 with respect to time t. In this example of cross-carrier scheduling, the scheduling serving cell 1465 is a licensed carrier and the scheduled serving cell is an unlicensed carrier (e.g., LAA cell). LBT may be performed in the DL subframe 1423 on the scheduled serving cell 1467 (i.e., the LAA SCell). In this example, CCA 1477 follows a busy 1475 period.

In the approach illustrated in FIG. 14, EPDCCH 1469 search spaces (or an EPDCCH PRB set with the new EREG/ECCE structure) may be shared by DL assignment and UL grant. The PDSCH 1471 in subframe n may be scheduled by the DL assignment in subframe n. On the other hand, PUSCH 1479 in subframe n may be scheduled by the UL grant in subframe n−4.

FIG. 15 is a block diagram illustrating another example of search space sharing for DL assignment and UL grant. A DL subframe 1523 is shown for both a scheduling serving cell 1565 and a scheduled serving cell 1567 with respect to time t. An UL subframe is also shown for the scheduled serving cell 1567 with respect to time t. In this example of cross-carrier scheduling, the scheduling serving cell 1565 is a licensed carrier and the scheduled serving cell is an unlicensed carrier (e.g., LAA cell). LBT may be performed in the DL subframe 1523 on the scheduled serving cell 1567 (i.e., the LAA SCell). In this example, CCA 1577 follows a busy 1575 period.

In the approach illustrated in FIG. 15, EPDCCH search spaces (or EPDCCH PRB set) for the UL grant may be defined (or configured) independently of those for the DL assignment. The PDSCH 1571 in subframe n may be scheduled by the DL assignment in subframe n. On the other hand, PUSCH 1579 in subframe n may be scheduled by the UL grant in subframe n−4. The EPDCCH 1569a starting position for the UL grant may be based on either CFI or a dedicated RRC message. The EPDCCH 1569b starting position for the DL assignment may be derived by either one of the above options (e.g., Option 1-3). Moreover, EPDCCH structures may also be independent between EPDCCH search spaces (or EPDCCH PRB set) for the UL grant and those for the DL assignment. The existing EPDCCH structure may be applied for the EPDCCH carrying the UL grant while the new EPDCCH structure may be applied for the EPDCCH carrying the DL assignment.

FIG. 16 is a block diagram illustrating yet another example of search space sharing for DL assignment and UL grant. A DL subframe 1623 is shown for both a scheduling serving cell 1665 and a scheduled serving cell 1667 with respect to time t. An UL subframe is also shown for the scheduled serving cell 1667 with respect to time t. In this example of cross-carrier scheduling, the scheduling serving cell 1665 is a licensed carrier and the scheduled serving cell 1667 is an unlicensed carrier (e.g., LAA cell). LBT may be performed in the DL subframe 1623 on the scheduled serving cell 1667 (i.e., the LAA SCell). In this example, CCA 1677 follows a busy 1675 period.

In the approach illustrated in FIG. 16, the EPDCCH search spaces (or the EPDCCH PRB set) for the UL grant may be defined (or configured) either independently of those for the DL assignment or may be shared by DL assignment and UL grant. The PDSCH 1671 in subframe n may be scheduled by the DL assignment in subframe n. On the other hand, PUSCH 1679 in subframe n may be scheduled by the UL grant in subframe n−4. In this case, the EPDCCH 1669b that schedules PDSCH 1671 may also schedule PUSCH 1679. Alternatively, another EPDCCH 1669a may schedule PUSCH 1679.

FIG. 17 is a block diagram illustrating an example of PDCCH-based self-scheduling for an LAA cell. Two subframes 1723 are shown with respect to time t. A first subframe 1723a is also referred to as subframe i−1. A second subframe 1723b is also referred to as subframe i. In these examples of self-scheduling, the scheduling serving cell 1765 is also the scheduled serving cell. In this example, the scheduling serving cell 1765 may be an LAA SCell.

In case (a), scheduling serving cell 1767a may perform LBT in the DL subframe 1723a where, CCA 1777a follows a busy 1775a period. In this case, the PDCCH 1785a in subframe i may carry the DL assignment for a shorter transmission time interval (TTI) mapped in the PDSCH 1771a of subframe i−1.

In case (b), scheduling serving cell 1767b may perform LBT in the DL subframe 1723b where, CCA 1777b follows a busy 1775b period. In this case, the PDCCH 1785b in subframe i may carry the DL assignment for a longer TTI (also referred to as a super TTI) mapped across the PDSCH 1771b of subframe i−1 and that of subframe i.

In case (c), scheduling serving cell 1767c may perform LBT in the DL subframe 1723c where, CCA 1777c follows a busy 1775c period. In this case, the PDCCH 1785c in subframe i may carry the DL assignment for a normal TTI (1 ms long TTI) mapped across the PDSCH 1771c of subframe i−1 and that of subframe i. Here, TTI may correspond to a transport block size (TBS), because transport block is generated per TTI. In other words, short and long TTIs are corresponding to small and large TBSs respectively.

FIG. 18 is a block diagram illustrating another example of PDCCH-based cross-carrier scheduling for an LAA cell. Two subframes 1823 are shown with respect to time t. A first subframe 1823a is also referred to as subframe i−1. A second subframe 1823b is also referred to as subframe i. In this example of cross-carrier scheduling, the scheduling serving cell 1865 is a licensed carrier and the scheduled serving cell 1867 is an unlicensed carrier (e.g., LAA cell). LBT may be performed in the subframe 1823 on the scheduled serving cell 1867 (i.e., the LAA SCell). In this example, CCA 1877 follows a busy 1875 period.

For cross-carrier scheduling for an LAA SCell, the PDCCH 1885 on the scheduling serving cell 1865 in subframe i may carry the DL assignment for the PDSCH 1871 on the scheduled serving cell 1867 in subframe i−1. As shown in FIG. 18, this principle can be applied regardless of the TTI type (i.e., cases (a) to (c)) in FIG. 17.

In this case, if the UE 102 is configured with CIF and if the DCI format size is the same, the search space in subframe i for the PDCCH 1885 scheduling resources in subframe i−1 on the LAA SCell may be used for self-scheduling within subframe i. More specifically, the eNB 160 may transmit, in subframe i, the PDCCH 1885 for the subframe i of the non-LAA cell using the search space for the PDCCH 1885 for the subframe i−1 of the LAA cell. The UE 102 may monitor the PDCCH 1885 for the subframe i of the non-LAA cell on the search space for the PDCCH 1885 for the subframe i−1 of the LAA cell. Similarly, the search space for the PDCCH 1885 carrying DL assignment for the subframe i−1 can be used for the PDCCH 1885 carrying UL grant for the subframe i+4.

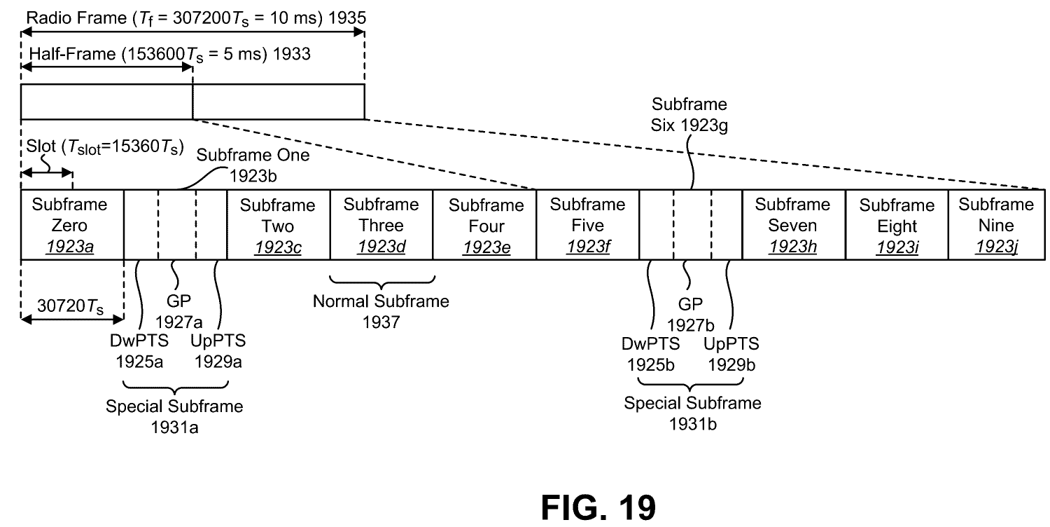

FIG. 19 is a diagram illustrating one example of a radio frame 1935 that may be used in accordance with the systems and methods disclosed herein. This radio frame 1935 structure illustrates a TDD structure. Each radio frame 1935 may have a length of T_{f}=307200·Tₛ=10 ms, where T_{f} is a radio frame 1935 duration and Tₛ is a time unit equal to 1/(15000×2048) seconds. The radio frame 1935 may include two half-frames 1933, each having a length of 153600·Tₛ=5 ms. Each half-frame 1933 may include five subframes 1923a-e, 1923f-j each having a length of 30720·Tₛ=1 ms.

TDD UL/DL configurations 0-6 are given below in Table (10) (from Table 4.2-2 in 3GPP TS 36.211). UL/DL configurations with both 5 millisecond (ms) and 10 ms downlink-to-uplink switch-point periodicity may be supported. In particular, seven UL/DL configurations are specified in 3GPP specifications, as shown in Table (10) below. In Table (10), “D” denotes a downlink subframe, “S” denotes a special subframe and “U” denotes a UL subframe.

TABLE 10

| TDD | Downlink- | | | | | | | | | | |
|---|---|---|---|---|---|---|---|---|---|---|---|
| UL/DL | to-Uplink | | | | | | | | | | |
| Config- | Switch- | | | | | | | | | | |
| uration | Point | Subframe Number | | | | | | | | | |
| Number | Periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table (10) above, for each subframe in a radio frame, “D” indicates that the subframe is reserved for downlink transmissions, “U” indicates that the subframe is reserved for uplink transmissions and “S” indicates a special subframe with three fields: a downlink pilot time slot (DwPTS), a guard period (GP) and an uplink pilot time slot (UpPTS). The length of DwPTS and UpPTS is given in Table (11) (from Table 4.2-1 of 3GPP TS 36.211) subject to the total length of DwPTS, GP and UpPTS being equal to 30720·Tₛ=1 ms. In Table (11), “cyclic prefix” is abbreviated as “CP” and “configuration” is abbreviated as “Config” for convenience.

TABLE (11)

| | Normal CP in downlink | | | Extended CP in downlink | | |
|---|---|---|---|---|---|---|
| Special | | UpPTS | | | UpPTS | |
| Sub- | | Normal | Extended | | Normal | Extended |
| frame | | CP in | CP in | | CP in | CP in |
| Config | DwPTS | uplink | uplink | DwPTS | uplink | uplink |
| 0 | 6592 · T_{S} | 2192 · | 2560 · T_{S} | 7680 · T_{S} | 2192 · | 2560 · |
| 1 | 19760 · T_{S} | T_{S} | | 20480 · T_{S} | T_{S} | T_{S} |
| 2 | 21952 · T_{S} | | | 23040 · T_{S} | | |
| 3 | 24144 · T_{S} | | | 25600 · T_{S} | | |
| 4 | 26336 · T_{S} | | | 7680 · T_{S} | 4384 · | 5120 · |
| 5 | 6592 · T_{S} | 4384 · | 5120 · T_{S} | 20480 · T_{S} | T_{S} | T_{S} |
| 6 | 19760 · T_{S} | T_{S} | | 23040 · T_{S} | | |
| 7 | 21952 · T_{S} | | | — | — | — |
| 8 | 24144 · T_{S} | | | — | — | — |

UL/DL configurations with both 5 ms and 10 ms downlink-to-uplink switch-point periodicity are supported. In the case of 5 ms downlink-to-uplink switch-point periodicity, the special subframe exists in both half-frames. In the case of 10 ms downlink-to-uplink switch-point periodicity, the special subframe exists in the first half-frame only. Subframes 0 and 5 and DwPTS may be reserved for downlink transmission. UpPTS and the subframe immediately following the special subframe may be reserved for uplink transmission.

In accordance with the systems and methods disclosed herein, some types of subframes 1923 that may be used include a downlink subframe, an uplink subframe and a special subframe 1931. In the example illustrated in FIG. 19, which has a 5 ms periodicity, two standard special subframes 1931a-b are included in the radio frame 1935. The remaining subframes 1923 are normal subframes 1937.

The first special subframe 1931a includes a downlink pilot time slot (DwPTS) 1925a, a guard period (GP) 1927a and an uplink pilot time slot (UpPTS) 1929a. In this example, the first standard special subframe 1931a is included in subframe one 1923b. The second standard special subframe 1931b includes a downlink pilot time slot (DwPTS) 1925b, a guard period (GP) 1927b and an uplink pilot time slot (UpPTS) 1929b. In this example, the second standard special subframe 1931b is included in subframe six 1923g. The length of the DwPTS 1925a-b and UpPTS 1929a-b may be given by Table 4.2-1 of 3GPP TS 36.211 (illustrated in Table (11) above) subject to the total length of each set of DwPTS 1925, GP 1927 and UpPTS 1929 being equal to 30720·Tₛ=1 ms.

Each subframe i 1923a-j (where i denotes a subframe ranging from subframe zero 1923a (e.g., 0) to subframe nine 1923j (e.g., 9) in this example) is defined as two slots, 2i and 2i+1 of length Tₛₗₒₜ=15360·Tₛ=0.5 ms in each subframe 1923. For example, subframe zero (e.g., 0) 1923a may include two slots, including a first slot.

UL/DL configurations with both 5 ms and 10 ms downlink-to-uplink switch-point periodicity may be used in accordance with the systems and methods disclosed herein. FIG. 19 illustrates one example of a radio frame 1935 with 5 ms switch-point periodicity. In the case of 5 ms downlink-to-uplink switch-point periodicity, each half-frame 1933 includes a standard special subframe 1931a-b. In the case of 10 ms downlink-to-uplink switch-point periodicity, a special subframe 1931 may exist in the first half-frame 1933 only.

Subframe zero (e.g., 0) 1923a and subframe five (e.g., 5) 1923f and DwPTS 1925a-b may be reserved for downlink transmission. The UpPTS 1929a-b and the subframe(s) immediately following the special subframe(s) 1931a-b (e.g., subframe two 1923c and subframe seven 1923h) may be reserved for uplink transmission. It should be noted that, in some implementations, special subframes 1931 may be considered DL subframes in order to determine a set of DL subframe associations that indicate UCI transmission uplink subframes of a UCI transmission cell.

LTE license access with TDD can have the special subframe as well as the normal subframe. The lengths of DwPTS, GP and UpPTS can be configured by using a special subframe configuration. Any one of the following ten configurations may be set as a special subframe configuration.

1) Special subframe configuration 0: DwPTS consists of 3 OFDM symbols. UpPTS consists of 1 single carrier frequency-division multiple access (SC-FDMA) symbol.

2) Special subframe configuration 1: DwPTS consists of 9 OFDM symbols for normal CP and 8 OFDM symbols for extended CP. UpPTS consists of 1 SC-FDMA symbol.

3) Special subframe configuration 2: DwPTS consists of 10 OFDM symbols for normal CP and 9 OFDM symbols for extended CP. UpPTS consists of 1 SC-FDMA symbol.

4) Special subframe configuration 3: DwPTS consists of 11 OFDM symbols for normal CP and 10 OFDM symbols for extended CP. UpPTS consists of 1 SC-FDMA symbol.

5) Special subframe configuration 4: DwPTS consists of 12 OFDM symbols for normal CP and 3 OFDM symbols for extended CP. UpPTS consists of 1 SC-FDMA symbol for normal CP and 2 SC-FDMA symbol for extended CP.

6) Special subframe configuration 5: DwPTS consists of 3 OFDM symbols for normal CP and 8 OFDM symbols for extended CP. UpPTS consists of 2 SC-FDMA symbols.

7) Special subframe configuration 6: DwPTS consists of 9 OFDM symbols. UpPTS consists of 2 SC-FDMA symbols.

8) Special subframe configuration 7: DwPTS consists of 10 OFDM symbols for normal CP and 5 OFDM symbols for extended CP. UpPTS consists of 2 SC-FDMA symbols.

9) Special subframe configuration 8: DwPTS consists of 11 OFDM symbols. UpPTS consists of 2 SC-FDMA symbols. Special subframe configuration 8 can be configured only for normal CP.

10) Special subframe configuration 9: DwPTS consists of 6 OFDM symbols. UpPTS consists of 2 SC-FDMA symbols. Special subframe configuration 9 can be configured only for normal CP.

FIG. 20 is a diagram illustrating one example of a resource grid. The resource grid illustrated in FIG. 20 may be utilized in some implementations of the systems and methods disclosed herein. More detail regarding the resource grid is given in connection with FIG. 1.

In FIG. 20, one downlink subframe 2069 may include two downlink slots 2083. N^{DL}_{RB} is downlink bandwidth configuration of the serving cell, expressed in multiples of N^{RB}_{sc}, where N^{RB}_{sc} is a resource block 2087 size in the frequency domain expressed as a number of subcarriers, and N^{DL}_{synth} is the number of OFDM symbols in a downlink slot 2083. A resource block 2087 may include a number of resource elements (RE) 2089.

For a PCell, N^{DL}_{RB} is broadcast as a part of system information. For an SCell (including an LAA SCell), N^{DL}_{RB} is configured by a RRC message dedicated to a UE 102. For PDSCH mapping, the available RE 2089 may be the RE 2089 whose index 1 fulfils l≧l_{data,start} and/or l_{data,end}≧l in a subframe.

Similarly, an uplink resource grid can be expressed using N^{UL}_{RB}, N^{RB}_{sc}, N^{UL}_{symb}. N^{UL}_{RB} is the uplink bandwidth configuration of the serving cell, expressed in multiples of N^{RB}_{sc}, where N^{RB}_{sc} is a resource block size in the frequency domain expressed as a number of subcarriers, and N^{UL}_{symb} is the number of OFDM symbols in an uplink slot.

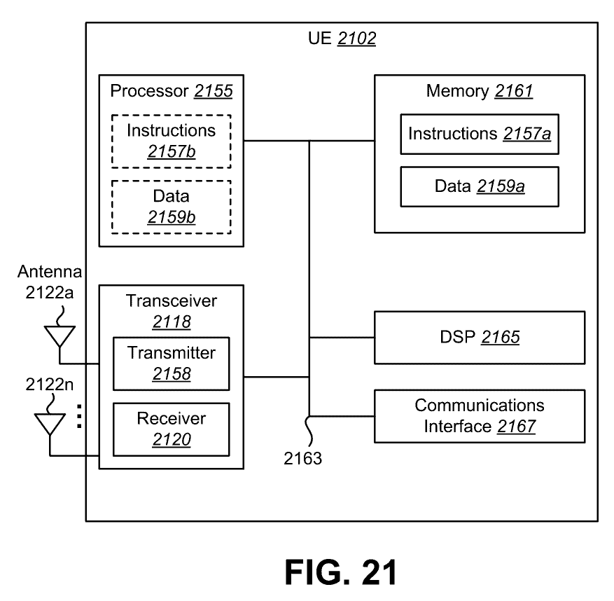

FIG. 21 illustrates various components that may be utilized in a UE 2102. The UE 2102 described in connection with FIG. 21 may be implemented in accordance with the UE 102 described in connection with FIG. 1. The UE 2102 includes a processor 2155 that controls operation of the UE 2102. The processor 2155 may also be referred to as a central processing unit (CPU). Memory 2161, which may include read-only memory (ROM), random access memory (RAM), a combination of the two or any type of device that may store information, provides instructions 2157a and data 2159a to the processor 2155. A portion of the memory 2161 may also include non-volatile random access memory (NVRAM). Instructions 2157b and data 2159b may also reside in the processor 2155. Instructions 2157b and/or data 2159b loaded into the processor 2155 may also include instructions 2157a and/or data 2159a from memory 2161 that were loaded for execution or processing by the processor 2155. The instructions 2157b may be executed by the processor 2155 to implement one or more of the method 300 described above.

The UE 2102 may also include a housing that contains one or more transmitters 2158 and one or more receivers 2120 to allow transmission and reception of data. The transmitter(s) 2158 and receiver(s) 2120 may be combined into one or more transceivers 2118. One or more antennas 2122a-n are attached to the housing and electrically coupled to the transceiver 2118.

The various components of the UE 2102 are coupled together by a bus system 2163, which may include a power bus, a control signal bus and a status signal bus, in addition to a data bus. However, for the sake of clarity, the various buses are illustrated in FIG. 21 as the bus system 2163. The UE 2102 may also include a digital signal processor (DSP) 2165 for use in processing signals. The UE 2102 may also include a communications interface 2167 that provides user access to the functions of the UE 2102. The UE 2102 illustrated in FIG. 21 is a functional block diagram rather than a listing of specific components.

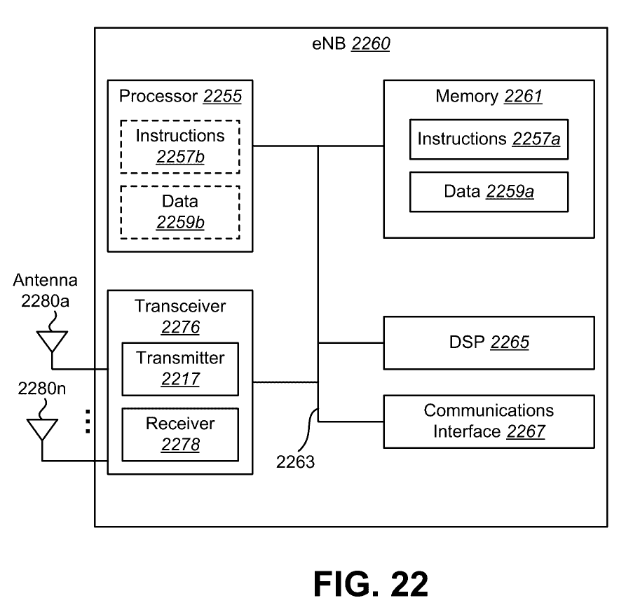

FIG. 22 illustrates various components that may be utilized in an eNB 2260. The eNB 2260 described in connection with FIG. 22 may be implemented in accordance with the eNB 160 described in connection with FIG. 1. The eNB 2260 includes a processor 2255 that controls operation of the eNB 2260. The processor 2255 may also be referred to as a central processing unit (CPU). Memory 2261, which may include read-only memory (ROM), random access memory (RAM), a combination of the two or any type of device that may store information, provides instructions 2257a and data 2259a to the processor 2255. A portion of the memory 2261 may also include non-volatile random access memory (NVRAM). Instructions 2257b and data 2259b may also reside in the processor 2255. Instructions 2257b and/or data 2259b loaded into the processor 2255 may also include instructions 2257a and/or data 2259a from memory 2261 that were loaded for execution or processing by the processor 2255. The instructions 2257b may be executed by the processor 2255 to implement one or more of the method 400 described above.

The eNB 2260 may also include a housing that contains one or more transmitters 2217 and one or more receivers 2278 to allow transmission and reception of data. The transmitter(s) 2217 and receiver(s) 2278 may be combined into one or more transceivers 2276. One or more antennas 2280a-n are attached to the housing and electrically coupled to the transceiver 2276.

The various components of the eNB 2260 are coupled together by a bus system 2263, which may include a power bus, a control signal bus and a status signal bus, in addition to a data bus. However, for the sake of clarity, the various buses are illustrated in FIG. 22 as the bus system 2263. The eNB 2260 may also include a digital signal processor (DSP) 2265 for use in processing signals. The eNB 2260 may also include a communications interface 2267 that provides user access to the functions of the eNB 2260. The eNB 2260 illustrated in FIG. 22 is a functional block diagram rather than a listing of specific components.

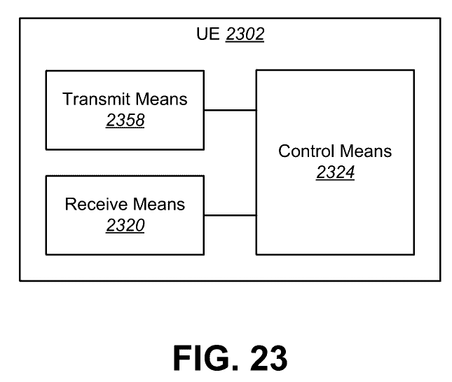

FIG. 23 is a block diagram illustrating one implementation of a UE 2302 in which systems and methods for performing LAA may be implemented. The UE 2302 includes transmit means 2358, receive means 2320 and control means 2324. The transmit means 2358, receive means 2320 and control means 2324 may be configured to perform one or more of the functions described in connection with FIG. 1 above. FIG. 21 above illustrates one example of a concrete apparatus structure of FIG. 23. Other various structures may be implemented to realize one or more of the functions of FIG. 1. For example, a DSP may be realized by software.

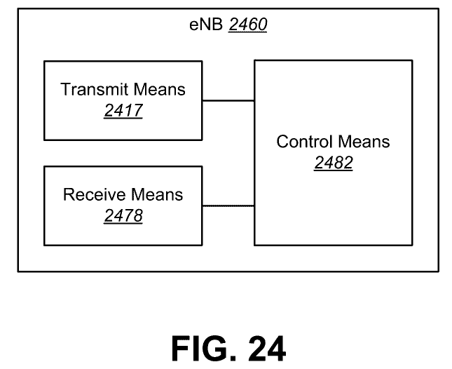

FIG. 24 is a block diagram illustrating one implementation of an eNB 2460 in which systems and methods for performing LAA may be implemented. The eNB 2460 includes transmit means 2417, receive means 2478 and control means 2482. The transmit means 2417, receive means 2478 and control means 2482 may be configured to perform one or more of the functions described in connection with FIG. 1 above. FIG. 22 above illustrates one example of a concrete apparatus structure of FIG. 24. Other various structures may be implemented to realize one or more of the functions of FIG. 1. For example, a DSP may be realized by software.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

A program running on the eNB 160 or the UE 102 according to the described systems and methods is a program (a program for causing a computer to operate) that controls a CPU and the like in such a manner as to realize the function according to the described systems and methods. Then, the information that is handled in these apparatuses is temporarily stored in a RAM while being processed. Thereafter, the information is stored in various ROMs or HDDs, and whenever necessary, is read by the CPU to be modified or written. As a recording medium on which the program is stored, among a semiconductor (for example, a ROM, a nonvolatile memory card, and the like), an optical storage medium (for example, a DVD, a MO, a MD, a CD, a BD, and the like), a magnetic storage medium (for example, a magnetic tape, a flexible disk, and the like), and the like, any one may be possible. Furthermore, in some cases, the function according to the described systems and methods described above is realized by running the loaded program, and in addition, the function according to the described systems and methods is realized in conjunction with an operating system or other application programs, based on an instruction from the program.

Furthermore, in a case where the programs are available on the market, the program stored on a portable recording medium can be distributed or the program can be transmitted to a server computer that connects through a network such as the Internet. In this case, a storage device in the server computer also is included. Furthermore, some or all of the eNB 160 and the UE 102 according to the systems and methods described above may be realized as an LSI that is a typical integrated circuit. Each functional block of the eNB 160 and the UE 102 may be individually built into a chip, and some or all functional blocks may be integrated into a chip. Furthermore, a technique of the integrated circuit is not limited to the LSI, and an integrated circuit for the functional block may be realized with a dedicated circuit or a general-purpose processor. Furthermore, if with advances in a semiconductor technology, a technology of an integrated circuit that substitutes for the LSI appears, it is also possible to use an integrated circuit to which the technology applies.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

What is claimed is:

1. A user equipment (UE) comprising:
a higher layer processor configured to acquire a Radio Resource Control (RRC) message for configuration of a first serving cell and an RRC message for configuration of a second serving cell as a scheduling cell for the first serving cell; and
a physical downlink control channel receiver configured to monitor a physical downlink control channel (PDCCH) with a first DCI format on the first serving cell, the PDCCH with the first DCI format scheduling a physical downlink shared channel (PDSCH) in the first serving cell, and to monitor a PDCCH with a second DCI format on the second serving cell, the PDCCH with the second DCI format scheduling a PDSCH in the first serving cell.

2. The UE of claim 1, wherein:
the higher layer processor is further configured to acquire an RRC message for configuration of a third serving cell as another scheduling cell for the first serving cell; and
the physical downlink control channel receiver is further configured, upon the configuration of the third serving cell, to monitor the PDCCH with the first DCI format on the third serving cell instead of the first serving cell.

3. A method, comprising:
acquiring a Radio Resource Control (RRC) message for configuration of a first serving cell and an RRC message for configuration of a second serving cell as a scheduling cell for the first serving cell;
monitoring a physical downlink control channel (PDCCH) with a first DCI format on the first serving cell, the PDCCH with the first DCI format scheduling a physical downlink shared channel (PDSCH) in the first serving cell; and
monitoring a PDCCH with a second DCI format on the second serving cell, the PDCCH with the second DCI format scheduling a PDSCH in the first serving cell.

4. The method of claim 3, further comprising:
acquiring an RRC message for configuration of a third serving cell as another scheduling cell for the first serving cell; and
monitoring the PDCCH with the first DCI format on the third serving cell instead of the first serving cell upon the configuration of the third serving cell.

5. An evolved NodeB (eNB), comprising:
a higher layer processor configured to transmit a Radio Resource Control (RRC) message for configuration of a first serving cell and an RRC message for configuration of a second serving cell as a scheduling cell for the first serving cell; and
a physical downlink control channel transmitter configured to transmit a physical downlink control channel (PDCCH), which schedules a physical downlink shared channel (PDSCH) in the first serving cell, on the first serving cell when a first DCI format is used, and to transmit a PDCCH, which schedules the PDSCH in the first serving cell, on the second serving cell when a second DCI format is used.

6. The eNB of claim 5, wherein:
the higher layer processor is further configured to transmit an RRC message for configuration of a third serving cell as another scheduling cell for the first serving cell; and
the physical downlink control channel transmitter is further configured, upon the configuration of the third serving cell, to transmit the PDCCH with the first DCI format on the third serving cell instead of the first serving cell.

7. A method, comprising:
transmitting a Radio Resource Control (RRC) message for configuration of a first serving cell and an RRC message for configuration of a second serving cell as a scheduling cell for the first serving cell;
transmitting a physical downlink control channel (PDCCH), which schedules a physical downlink shared channel (PDSCH) in the first serving cell, on the first serving cell when a first DCI format is used; and
transmitting a PDCCH, which schedules the PDSCH in the first serving cell, on the second serving cell when a second DCI format is used.

8. The method of claim 7, further comprising:
transmitting an RRC message for configuration of a third serving cell as another scheduling cell for the first serving cell; and
transmitting the PDCCH with the first DCI format on the third serving cell instead of the first serving cell upon the configuration of the third serving cell.
